(19) United States
(12) Patent Application Publication
(10) Pub. No.: US 2019/0168787 A1
(43) Pub. Date: Jun. 6, 2019

(54) INSPECTION SYSTEM AND METHOD

(71) Applicant: General Electric Company, Schenectady, NY (US)

(72) Inventors: Jason Howard Messinger, Andover, MA (US); Robert Carroll Ward, Essex, CT (US); Michael Christopher Domke, Skaneateles, NY (US); Sekhar Soorianarayanan, Bangalore (IN); Scott Leo Sbihli, Lexington, MA (US); Thomas Eldred Lambdin, Auburn, NY (US); Steven Clifton, Fountaindale (AU); Dattaraj Jagdish Rao, Bangalore (IN); Anju Bind, Bangalore (IN); Glenn Robert Shaffer, Erie, PA (US); Peter Henry Tu, Niskayuna, NY (US); Mark Bradshaw Kraeling, Melbourne, FL (US); Anwarul Azam, Lawrence Park, PA (US); Matthew Lawrence Blair, Lawrence Park, PA (US); Shannon Joseph Clouse, Lawrence Park, PA (US)

(21) Appl. No.: 16/229,824

(22) Filed: Dec. 21, 2018

Related U.S. Application Data
(63) Continuation-in-part of application No. 13/747,443, filed on Jan. 22, 2013.
Application No. 13/747,443 is a continuation-in-part of application No. 13/747,416, filed on Jan. 22, 2013.
Application No. 13/747,416 is a continuation-in-part of application No. 16/129,405, filed on Sep. 12, 2018.
Application No. 16/129,405 is a continuation-in-part of application No. 16/195,950, filed on Nov. 20, 2018.
Application No. 16/195,950 is a continuation-in-part of application No. 14/457,353, filed on Aug. 12, 2014.
Application No. 14/457,353 is a continuation-in-part of application No. 13/888,941, filed on May 7, 2013, now Pat. No. 10,271,017.
Application No. 16/129,405 is a continuation-in-part of application No. 15/226,151, filed on Aug. 2, 2016, now Pat. No. 10,101,432.
Application No. 16/195,950 is a continuation of application No. 15/651,630, filed on Jul. 17, 2017.
Application No. 16/195,950 is a continuation-in-part of application No. 14/624,069, filed on Feb. 17, 2015, now Pat. No. 9,873,442.
Application No. 14/624,069 is a continuation-in-part of application No. 15/044,592, filed on Feb. 16, 2016.
Application No. 15/044,592 is a continuation-in-part of application No. 11/750,716, filed on May 18, 2007, now abandoned.
Application No. 11/750,716 is a continuation-in-part of application No. 11/385,354, filed on Mar. 20, 2006, now Pat. No. 9,733,625.
Application No. 11/385,354 is a continuation-in-part of application No. 14/541,370, filed on Nov. 14, 2014, now Pat. No. 10,110,795.
Application No. 14/541,370 is a continuation-in-part of application No. 14/217,672, filed on Mar. 18, 2014.
Application No. 14/217,672 is a continuation-in-part of application No. 14/253,294, filed on Apr. 15, 2014, now Pat. No. 9,875,414.
Application No. 14/253,294 is a continuation-in-part of application No. 14/457,353, filed on Aug. 12, 2014.
Application No. 14/457,353 is a continuation-in-part of application No. 14/479,847, filed on Sep. 8, 2014, now abandoned.
Application No. 14/479,847 is a continuation-in-part of application No. 14/485,398, filed on Sep. 12, 2014, now Pat. No. 10,049,298.
Application No. 14/485,398 is a continuation-in-part of application No. 13/109,209, filed on May 17, 2011, now Pat. No. 8,913,131.
Application No. 13/109,209 is a division of application No. 11/146,831, filed on Jun. 6, 2005, now Pat. No. 7,965,312.
Application No. 11/146,831 is a continuation-in-part of application No. 10/361,968, filed on Feb. 10, 2003, now abandoned.
Application No. 10/361,968 is a continuation-in-part of application No. 14/922,787, filed on Oct. 26, 2015.
Application No. 14/922,787 is a continuation-in-part of application No. 14/155,454, filed on Jan. 15, 2014, now Pat. No. 9,671,358.
Application No. 14/155,454 is a continuation-in-part of application No. 12/573,141, filed on Oct. 4, 2009, now Pat. No. 9,233,696.
(60) Provisional application No. 61/940,660, filed on Feb. 17, 2014.
(60) Provisional application No. 61/940,610, filed on Feb. 17, 2014.
(60) Provisional application No. 61/940,813, filed on Feb. 17, 2014.
(60) Provisional application No. 61/940,696, filed on Feb. 17, 2014.
(60) Provisional application No. 61/700,490, filed on Sep. 13, 2012.
(60) Provisional application No. 62/403,963, filed on Oct. 4, 2016.
(60) Provisional application No. 60/894,006, filed on Mar. 9, 2007.
(60) Provisional application No. 61/940,813, filed on Feb. 17, 2014.
(60) Provisional application No. 61/940,660, filed on Feb. 17, 2014.
(60) Provisional application No. 61/940,610, filed on Feb. 17, 2014.
(60) Provisional application No. 61/940,696, filed on Feb. 17, 2014.
(60) Provisional application No. 61/940,813, filed on Feb. 17, 2014.
(60) Provisional application No. 60/626,573, filed on Nov. 10, 2004.
(60) Provisional application No. 60/385,645, filed on Jun. 4, 2002.
(60) Provisional application No. 62/134,518, filed on Mar. 17, 2015.
(60) Provisional application No. 62/134,518, filed on Mar. 17, 2015.

(51) Int. Cl. B61L 25/02; B61L 15/00; B61L 27/00; B64C 39/02; B64D 47/08; G06K 9/00; H04N 7/18; H04L 29/08; G05D 1/00; H04N 5/232

(52) U.S. Cl. CPC B61L 25/021; B61L 23/04; B61L 15/009; B61L 15/0072; B61L 27/0077; B64C 39/024; B64D 47/08; G06K 9/00651; B61L 15/0027; B61L 27/0088; B61L 27/0094; B61L 25/026; B61L 25/023; B61L 25/025; H04N 7/183; H04L 67/12; G05D 1/0094; H04N 5/23241; H04N 5/23206; H04N 5/23203; G06K 9/00798; G06K 9/00771; B61L 15/0081

(57) ABSTRACT

An inspection management system is provided. The inspection management system includes an inspection data provider that receives inspection data relating to an inspector, one or more devices used to complete an inspection, one or more assets associated with an inspection, an inspection plan, etc. A display of the inspection management system presents one or more graphical user interfaces based upon the inspection data. The graphical user interfaces may facilitate inspection planning, execution, preparation, and/or real-time inspection monitoring.

### CROSS-REFERENCE TO RELATED APPLICATIONS

This application is a continuation-in-part of U.S. patent application Ser. No. 13/747,443, filed 22 Jan. 2013; is a continuation-in-part of U.S. patent application Ser. No. 13/747,416, also filed on 22 Jan. 2013; is a continuation-in-part of U.S. patent application Ser. No. 16/129,405, filed 12 Sep. 2018 (the “'405 Application”); is a continuation-in-part of U.S. patent application Ser. No. 16/195,950, filed 20 Nov. 2018 (the “'950 Application”); is a continuation-in-part of U.S. patent application Ser. No. 14/457,353, filed 12 Aug. 2014 (the “'353 Application”); and is a continuation-in-part of U.S. patent application Ser. No. 13/888,941, filed 7 May 2013 (the “'941 Application”).

The '353 Application claims priority to U.S. Provisional Application No. 61/940,660, which was filed on 17 Feb. 2014; U.S. Provisional Application No. 61/940,610, which also was filed on 17 Feb. 2014; U.S. Provisional Application No. 61/940,813, which was filed on 17 Feb. 2014; and U.S. Provisional Application No. 61/940,696, which was filed on 17 Feb. 2014.

The '941 Application claims priority to U.S. Provisional Patent Application No. 61/700,490, filed 13 Sep. 2012.

The '405 Application is a continuation-in-part of U.S. patent application Ser. No. 15/226,151, which was filed on 2 Aug. 2016 (now U.S. Pat. No. 10,101,432, issued 16 Oct. 2018).

The '950 Application is a continuation of U.S. patent application Ser. No. 15/651,630 filed on 17 Jul. 2017, which claims priority to U.S. Provisional Application No. 62/403,963, filed 4 Oct. 2016, is a continuation-in-part to U.S. patent application Ser. No. 14/624,069, filed 17 Feb. 2015 (now U.S. Pat. No. 9,873,442, issued 23 Jan. 2018) (the “'069 Application”) and is a continuation-in-part to U.S. patent application Ser. No. 15/044,592, filed 16 Feb. 2016 (the “'592 Application”).

The '950 Application is also a continuation-in-part of U.S. patent application Ser. No. 11/750,716 filed 18 May 2007, which is now abandoned and which claims priority to U.S. Provisional Application No. 60/894,006, filed 9 Mar. 2007, and is also a continuation-in part of U.S. application Ser. No. 11/385,354, filed 20 Mar. 2006 (now U.S. Pat. No. 9,733,625, issued 15 Aug. 2017).

The '069 Application claims priority to U.S. Provisional Application Nos. 61/940,813; 61/940,660; 61/940,610; and 61/940,696, all of which were filed on 17 Feb. 2014.

The '069 Application also is a continuation-in-part of U.S. patent application Ser. No. 14/541,370, filed 14 Nov. 2014 (now U.S. Pat. No. 10,110,795, issued 23 Oct. 2018) (the “'370 Application”), which claims priority to U.S. Provisional Application No. 61/940,813, filed 17 Feb. 2014. The '370 Application is a continuation-in-part of U.S. patent application Ser. No. 14/217,672, filed 14 Mar. 2014, U.S. patent application Ser. No. 14/253,294, filed 15 Apr. 2014, U.S. patent application Ser. No. 14/457,353, filed 12 Aug. 2014, U.S. patent application Ser. No. 14/479,847, filed 8 Sep. 2014, U.S. patent application Ser. No. 14/485,398, filed 12 Sep. 2014, and U.S. patent application Ser. No. 13/109,209, filed 17 May 2011 (now U.S. Pat. No. 8,913,131, issued 16 Dec. 2014) (the “'209 Application”).

The '209 Application is a divisional application of U.S. patent application Ser. No. 11/146,831, filed 6 Jun. 2005 (now U.S. Pat. No. 7,965,312, issued 21 Jun. 2011) (the “'831 Application”), which claims priority to U.S. Provisional Application No. 60/626,573, filed 10 Nov. 2004.

The '831 Application also is a continuation-in-part of U.S. patent application Ser. No. 10/361,968, filed 10 Feb. 2003 (the “'968 Application”), which is now abandoned and which claims priority to U.S. Provisional Application No. 60/385,645, filed 4 Jun. 2002.

The '592 Application claims priority to U.S. Provisional Application No. 62/134,518, filed 17 Mar. 2015, and is a continuation-in-part of U.S. application Ser. No. 14/922,787, filed 26 Oct. 2015 (the '787 Application), which claims priority to U.S. Provisional Application No. 62/134,518, filed 17 Mar. 2015.

The '787 Application also is a continuation-in-part of U.S. application Ser. No. 14/155,454, filed 15 Jan. 2014 (now U.S. Pat. No. 9,671,358, issued 6 Jun. 2017) (the “'454 Application), and is a continuation-in-part of U.S. application Ser. No. 12/573,141, filed 4 Oct. 2009 (now U.S. Pat. No. 9,233,696, issued 12 Jan. 2016) (the '141 Application).

The '454 Application is a continuation of International Application No. PCT/US13/54284, filed 9 Aug. 2013, which claims priority to U.S. Provisional Application No. 61/681,843, filed 10 Aug. 2012, to U.S. Provisional Application No. 61/729,188, filed 21 Nov. 2012, to U.S. Provisional Application No. 61/860,469, filed 31 Jul. 2013, and to U.S. Provisional Application No. 61/860,496, filed 31 Jul. 2013.

The '141 Application is a continuation-in-part of U.S. application Ser. No. 11/385,354, filed 20 Mar. 2006 (now U.S. Pat. No. 9,733,625, issued 15 Aug. 2017).

The entire disclosures of all the foregoing applications and patents are incorporated herein by reference.

### BACKGROUND

### Technical Field

The subject matter disclosed herein relates to inspection management and inspection system. The subject matter disclosed herein relates to providing inspection information to a user.

### Discussion of Art

Certain equipment and facilities, such as power generation equipment and facilities, oil and gas equipment and facilities, vehicle equipment and facilities, manufacturing equipment and facilities, and the like, include a plurality of interrelated systems, and processes. For example, power generation plants may include turbine systems and processes for operating and maintaining the turbine systems. Likewise, oil and gas operations may include carbonaceous fuel retrieval systems and processing equipment interconnected via pipelines. Similarly, vehicle systems may include airplanes and maintenance hangars useful in maintaining airworthiness and providing for maintenance support; or locomotives and service bays; or marine vessels and shipyards; or automobiles and garages. During equipment operations, the equipment may degrade, encounter undesired conditions such as corrosion, wear and tear, and so on, potentially affecting overall equipment effectiveness. Certain inspection techniques, such as non-destructive inspection techniques or non-destructive testing (NDT) techniques, may be used to detect undesired equipment conditions.

In a conventional NDT system, data may be shared with other NDT operators or personnel using portable memory devices, paper, of through the telephone. As such, the amount of time to share data between NDT personnel may depend largely on the speed at which the physical portable memory device is physically dispatched to its target. Accordingly, it would be beneficial to improve the data sharing capabilities of the NDT system, for example, to more efficiently test and inspect a variety of systems and equipment. NDT relates to the examination of an object, material, or system without reducing future usefulness. In particular, NDT inspections may be used to determine the integrity of a product using time-sensitive inspection data relating to a particular product. For example, NDT inspections may observe the “wear and tear” of a product over a particular time-period.

Many forms of NDT are currently known. For example, perhaps the most common NDT method is visual examination. During a visual examination, an inspector may, for example, simply visually inspect an object for visible imperfections. Alternatively, visual inspections may be conducted using optical technologies such as a computer-guided camera, a borescope enabled visual device, etc. Radiography is another form of NDT. Radiography relates to using radiation (e.g., x-rays and/or gamma rays) to detect thickness and/or density changes to a product, which may denote a defect in the product. Further, ultrasonic testing relates to transmitting high-frequency sound waves into a product to detect changes and/or imperfections to the product. Using a pulse-echo technique, sound it introduced into the product and echoes from the imperfections are returned to a receiver, signaling that the imperfection exists. Many other forms of NDT exist. For example, magnetic particle testing, penetrant testing, electromagnetic testing, leak testing, and acoustic emission testing, to name a few.

A tremendous amount of time and effort is used to inspect these vehicles on a periodic basis. Further, historical data relating to previous inspections may be used to compare and contrast inspection results to understand trending data. Further, inspection data for an entire fleet of products (e.g., a fleet of vehicles) may be useful for inspection purposes, as may reference materials provided by a manufacturer or other source. Large amounts of data may be gathered and used in the inspection process. This data may be pulled from many sources and may be crucial for accurate inspection.

Managing inspections may be complex. There may be numerous assets or objects needing to be inspected across a multitude of geographies. Further, there may be a limited number of resources (e.g., inspectors and/or inspection devices) available to complete the inspections. In conventional inspection systems, inspection management has been a manual process, consuming a large amount of resources to plan, execute, and review inspections. Accordingly, improved systems and methods for managing inspections may be desirable.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, an inspection system is provided. The inspection system includes a sensor package that has one or more sensors that can obtain and provide inspection data relating to at least one target object; a support platform that can carry the sensor package to the at least one target object; a controller that can align or index the one or more sensors of the sensor package with or on at least a portion of the target object at least during an inspection operation, and communicate with at least one operator that is remote from the target object, and can: send inspection information from the one or more sensors to the at least one remote operator, and receive from the at least one remote operator one or more control instructions, programming instructions, and configuration instructions at the support platform, and thereby to control the inspection operation of the sensor package, and the controller can manipulate the one or more sensors at least in part in response to the received control instructions, programming instructions, and/or configuration instructions.

In one embodiment, an inspection system includes a sensor package including one or more sensors that can obtain and to provide inspection data relating to at least one target object, and the one or more sensors include at least a visual or optical system, and a non-visual, non-destructive inspection and testing device; a support platform that can carry the sensor package to the at least one target object; a navigation device that can provide at least location and direction information; a controller that can receive the at least location and direction information, and to align or index the one or more sensors of the sensor package to a determined aspect of the target object and execute one or move movements of the support platform relative to that determined aspect so as to sequentially expose the sensor package to portions of the target object in a determined pattern, and capture inspection information from the one or more sensors relating to the target object.

In one embodiment, a method includes directing one or more sensors of a sensor package toward at least a portion of a target object at least during an inspection operation to generate inspection information; communicating with at least one operator that is remote from the target object the inspection information; receiving one or more of control instructions, programming instructions, and configuration instructions; and manipulating the one or more sensors at least in part in response to the received control instructions, programming instructions, and/or configuration instructions. In one aspect, the method includes defining a crash avoidance residence zone to avoid contact between a support platform for the sensor package and one or more of: the target object, another support platform, or with an object other than the target object or another support platform.

### BRIEF DESCRIPTION OF THE DRAWINGS

These and other features and aspects of the invention are understood when the following detailed description is read with reference to the accompanying drawings in which like characters represent like parts throughout the drawings, wherein:

FIG. 1 is a block diagram illustrating an embodiment of a distributed non-destructive testing (NDT) system, including a mobile device;

FIG. 2 is a block diagram illustrating further details of an embodiment of the distributed NDT system of FIG. 1;

FIG. 3 is a front view illustrating an embodiment of a borescope system communicatively coupled to the mobile device of FIG. 1 and a “cloud;”

FIG. 4 is an illustration of an embodiment of a pan-tilt-zoom (PTZ) camera system communicatively coupled to the mobile device of FIG. 1;

FIG. 5 is a flowchart illustrating an embodiment of a process useful in using the distributed NDT system for planning, inspecting, analyzing, reporting, and sharing of data, such as inspection data;

FIG. 6 is a block diagram of an embodiment of information flow through a wireless conduit;

FIG. 7 is a flowchart illustrating a process for providing real-time inspection management data in a graphical user interface, in accordance with an embodiment;

FIG. 8 is a schematic diagram of an inspection management system, in accordance with an embodiment;

FIG. 9 is an example of an inspection management system graphical user interface (GUI), in accordance with an embodiment;

FIG. 10 is an example of a collaboration session GUI facilitated by an inspection management system, in accordance with an embodiment;

FIG. 11 is an alternative inspection management GUI, in accordance with an embodiment;

FIG. 12 is a flowchart illustrating a process for providing reference information during an inspection, in accordance with an embodiment;

FIG. 13 is a schematic diagram of an inspection system useful for providing reference information during an inspection, in accordance with an embodiment;

FIG. 14 is a schematic diagram of an alternate inspection system useful for providing reference information during an inspection, in accordance with an embodiment; and

FIGS. 15A and 15B are a schematic view of a progression of presenting step-specific supplemental data, in accordance with an embodiment.

### DETAILED DESCRIPTION

In one embodiment, a controller may be communicatively coupled to an inspection device, and may provide enhanced wireless display capabilities, remote control, data analytics and/or data communications to the inspection device. While other mobile devices may be used as a controller, in one embodiment a tablet may be apt for manual and semi-autonomous control insofar as the tablet may provide for a larger, higher resolution display, more powerful processing cores, an increased memory, and improved battery life. The tablet may provide visualization of data to aid the manipulatory control of the inspection device and extending collaborative sharing to a plurality of external systems and entities. The inspection device may be mobile and may be carried on a support platform to and/or within a reception area. A controller may maneuver the support platform carrying the inspection device into position relative to the target object in the reception area to be inspected (manually, semi-autonomously, or autonomously).

Aspects of this disclosure are directed towards sharing data acquired from the inspection system and/or control of applications and/or devices in the inspection system. Data generated from the inspection system may be distributed to various systems or groups of people using techniques disclosed herein. Moreover, content displayed by an application used to monitor and/or control devices in the inspection system may be shared to create a virtual collaborative environment for monitoring and controlling the devices in the inspection system. Suitable inspection devices may include various non-destructive testing (NDT) devices, such as cameras and the like, or a plurality of NDT devices. A sensor package, then, may include one or more NDT inspection devices, and the term sensor package may be used interchangeably with one or more inspection devices.

As used herein, a camera is a device for capturing and/or recording visual images. These images may be in the form of still shots, analog video signals, or digital video signals. The signals, particularly the digital video signals, may be subject to compression/decompression algorithms, such as MPEG or HEVC, for example. A suitable camera may capture and record in a determined band of wavelengths of light or energy. For example, in one embodiment the camera may sense wavelengths in the visible spectrum and in another the camera may sense wavelengths in the infrared spectrum. Multiple sensors may be combined in a single camera and may be used selectively based on the application. Further, stereoscopic and 3D cameras are contemplated for at least some embodiments described herein. These cameras may assist in determining distance, velocity, and vectors to predict (and thereby avoid) collision and damage. The term vehicle may be conveniently substituted for support platform or mobile equipment in some embodiments. A consist, or vehicle consist, refers to two or more vehicles or items of mobile equipment that are mechanically or logically coupled to each other. By ‘logically coupled’, the plural items of mobile equipment are controlled so that controls to move one of the items causes a corresponding movement in the other items in consist, such as by wireless command. An Ethernet over multiple unit (eMU) system may include, for example, a communication system for use transmitting data from one vehicle to another in consist (e.g., an Ethernet network over which data is communicated between two or more vehicles). Such a network may be wired or wireless.

The energy storage device may be electrically connected to the camera unit, the data storage device, and/or the communication device. The energy storage device can represent one or more devices that store and/or generate electric current to power the camera unit, the data storage device, and/or the communication device. For example, the energy storage device can include one or more batteries, pantographs (e.g., that receive current from an off-board source via a catenary or overhead line), conductive shoes (e.g., that contact a conductive body, such as an electrified rail, to receive current from an off-board source), generators, alternators, or the like.

In one embodiment, the sensor package or camera unit comprises a camera, a data storage device, and an energy storage device, but not a communication device. In such an embodiment, the camera unit may be used for storing captured image data for later retrieval and use. In another embodiment, the camera unit comprises the camera, the communication device, and the energy storage device, but not the data storage device. In such an embodiment, the portable camera unit may be used to communicate the image data to a vehicle or other location for immediate use (e.g., being displayed on a display screen), and/or for storage remote from the portable camera unit (this is, for storage not within the portable camera unit). In another embodiment, the camera unit comprises the camera, the communication device, the data storage device, and the energy storage device. In such an embodiment, the portable camera unit may have multiple modes of operation, such as a first mode of operation where image data is stored within the portable camera unit on the data storage device, and a second mode of operation where the image data is transmitted off the portable camera unit for remote storage and/or immediate use elsewhere.

The camera may be a digital video camera, such as a camera having a lens, an electronic sensor for converting light that passes through the lens into electronic signals, and a controller for converting the electronic signals output by the electronic sensor into the image data, which may be formatted according to a standard such as MP4. The data storage device, if present, may be a hard disc drive, flash memory (electronic non-volatile non-transitory computer storage medium), or the like. The communication device, if present, may be a wireless local area network (LAN) transmitter (e.g., Wi-Fi transmitter), a radio frequency (RF) transmitter that transmits in and according to one or more commercial cell frequencies/protocols (e.g., 3G or 4G), and/or an RF transmitter that is configured to wirelessly communicate at frequencies used for vehicle communications (e.g., at a frequency compatible with a wireless receiver of a distributed power system of a rail vehicle; distributed power refers to coordinated traction control, such as throttle and braking, of a train or other rail vehicle consist having plural locomotives or other powered rail vehicle units). A suitable energy storage device may be a rechargeable lithium-ion battery, a rechargeable Ni—Mh battery, an alkaline cell, or other device configured for portable energy storage for use in an electronic device. Another suitable energy storage device, albeit more of an energy provider than storage, include a vibration harvester and a solar panel, where energy is generated and then provided to the camera system.

The sensor package can include a locator device that generates data used to determine the location of the sensor package. The locator device can represent one or more hardware circuits or circuitry that include and/or are connected with one or more processors (e.g., controllers, microprocessors, or other electronic logic-based devices). In one example, the locator device represents one of a global positioning system (GPS) receiver, LIDAR, or time-of-flight controller that may determine a location of the camera unit, a beacon or other communication device that broadcasts or transmits a signal that is received by another component (e.g., the transportation system receiver) to determine how far the sensor package is from the component that receives the signal (e.g., the receiver), a radio frequency identification (RFID) tag or reader that emits and/or receives electromagnetic radiation to determine how far the sensor package is from another RFID reader or tag (e.g., the receiver), or the like. The receiver can receive signals from the locator device to determine the location of the locator device relative to the receiver and/or another location (e.g., relative to a target object). Additionally or alternatively, the locator device can receive signals from the receiver (e.g., which may include a transceiver capable of transmitting and/or broadcasting signals) to determine the location of the locator device relative to the receiver and/or another location (e.g., relative to a target object).

In one embodiment, the control system can prevent movement or operation of the target equipment (e.g., vehicle) responsive to a first data content of the image data and allow movement of the or operation of the target equipment responsive to a different, second data content of the image data. For example, the control system may engage brakes and/or prevent motors from moving the operation of the target equipment responsive to the first data content of the image data indicating that the camera unit is located in a position where it may be damaged by such operation, and to allow operation of the target equipment responsive to the second data content of the image data indicating that the camera unit is located in a safe zone such that operation would not cause injury or damage. Such interaction can temporarily halt normal operation of the target equipment so as to conduct an inspection operation.

In operation, as a sensor package coupled to the support platform may travel throughout a reception area, proximity detection units on board each support platform, via an emitter (e.g., transceiver), may synchronously transmit an RF signal (carrying the transceiver/emitter and/or vehicle ID) and an electromagnetic EM pulse. The proximity detection unit on board the support platform generates the RF and EM transmissions, respectively, which then propagate through space until they reach a target object and/or beacon within the reception area. A magnetic field receiver of a receiver unit (acting as the beacon) may receive the EM pulses, while an RF transceiver receives the RF signal. The start time of the received RF signal and the start and stop time of the detected EM pulse may be recorded by the controller and are used to verify the EM pulse duration and its synchronicity with the RF signal in order to link the RF signal and EM pulses to one another. The synchronous start of the RF signal and EM pulse may be verified on the receiving end (i.e., at the receiving unit). Likewise, an EM pulse duration, d, may be measured on the receiving end (i.e., at the receiving unit). This ensures that no two EM transmissions from two different transmitters can be mistaken for each other on the receiving end. The transmissions may be either received clearly and accepted, or rejected if the RF signal checksum fails or the EM signal duration is measured incorrectly due to a rare RF collision or EM noise.

Moreover, in order to arbitrate concurrent communications from competing transceivers, such as transceivers deployed on other support platforms within the reception area, the controller, on the high RF channel, may employ a listen-before-talk mechanism with a random back-off delay. In particular, the controller may, prior to generating the transmissions, sense or “listen” to the radio environment within the reception area to prevent concurrent transmission from competing transceivers. Essentially, the controller can ensure that the reception area is clear of competing transmission prior to RF and EM transmission.

After receiving the RF transmission and EM pulses, and linking the transmissions to one another to verify the source, a processing module of the receiver unit determines the distance between the receiver unit and the emitter on-board the first support platform in dependence upon the strength of the received magnetic field, where a certain level of a received signal indicates a certain distance. For example, in certain embodiments, the distance measurement may be based on the generated magnetic field intensity. In particular, the generated field power may be calibrated and known. The relationship between field intensity and distance is also known and sampled. The transceiver/receiver that receives the transmissions measures the field intensity and matches it with a prerecorded distance in a lookup table stored in memory of the processing module. In other embodiments, a model based on the known physical formulas for EM field propagation can be utilized.

As indicated above, the processing module of the receiver unit may be based at least in part on the emitted field strength (which could be a fixed value for the entire system). In other embodiments, the strength of the field emitted by the proximity detection unit may be transmitted from the proximity detection unit to the receiver unit via the RF channel in addition to the transceiver/vehicle ID information. The emitted field strength and the received field strength values may then be utilized by the processing module to calculate or determine the distance from the first vehicle from which the transmissions were made, such as via a lookup table or algorithm stored in memory. Once the field strength has been converted to a distance measurement by the processing module of the receiver unit, this measurement is communicated back to the proximity detection unit of the first support platform via the RF channel (i.e., RF transceiver to originating transceiver). This distance measurement may then be used by controller on board the first vehicle to determine a positional action to be taken (e.g., continue on route, change route, slow, stop, notify, move closer).

In addition to communicating the distance measurement back to the originating transceiver of the first support platform, the receiver unit may generate an alarm or alert if a preset ‘safety’ distance threshold has been breached. In an embodiment, the alert may be an audible alarm, a visual alert, or other sensory alert. For example, the receiver unit may activate one or more LEDs, vibrators, speakers or flash graphics or text on the tablet display for attracting a user's attention to the fact that a distance threshold has been breached. This alert may prompt an operator or the system to increase the distance between the support platform and the target object, or to seek a safe location. The proximity detection system may determine the proximity of vehicles operating within the reception area to the target object outfitted with the receiver unit, and to generate alerts or notifications (either at the receiver unit or the tablet, or both). In this way, operational safety within the reception area may be increased, and bottlenecking or backups may be minimized.

The RF transmission frequency of a high RF signal may include all frequencies within the megahertz (MHz) to gigahertz (GHz) range. Thus, in an embodiment, the high RF signal is at least 1 MHz. In various embodiments, the RF signal frequency is on the lower end of the MHz to GHz range. The higher the frequency, the quicker the signal, which allows more support platforms, with more sensor packages, to be present within the reception. Accordingly, a higher frequency may be utilized where a high volume of support platform traffic is anticipated. In certain embodiments, the frequency for the RF signal may be selected in dependence upon a number of factors including the number of support platforms that are anticipated or estimated to be present in a particular reception area at a given time and the particular application for which the system is used (e.g., on a roadway, within an underground mine, etc.). For example, in underground or underwater applications, it may be desirable to use a lower frequency for the RF signal, where a direct line-of-sight between support platforms operating within the space is not always present. This is because the lower the frequency, the less dependent the system is on the availability of a direct line-of-sight (which is often not possible within the many twists and turns of a mine, e.g.), due to the RF wave diffraction (i.e., bending around corners) and the ability to penetrate walls within the mine.

In an embodiment, the EM frequency may be as low as zero (i.e., a constant magnetic field, but not electrical). In such a case, the detector of the transceiver may sense a momentary change in the magnetic field of the earth and derive the induced vector from it, based on a pre-measured baseline. In an embodiment, the EM frequency may be selected to be as low as possible, as there are less induced currents in metallic objects placed in between the transmitter and receiver, and there is less of the associated field intensity loss due to such induced currents. In addition, selecting a low frequency for the EM pulses achieves a much higher immunity to various EM noises coming from possible electrical and electronic devices located within the reception area. Utilizing a constant magnetic field allows any alternating EM noise to be filtered out. In connection with the above, utilizing a constant magnetic field may be possible because the EM field is not used as a data carrier. This has heretofore not been possible with systems that may use the EM field as a data carrier.

As a result of the much shorter transmission time as compared to existing electromagnetic energy-based distance measuring systems, the time taken to measure the distance between the transmitter and receiver (i.e., the distance between vehicles), and to uniquely identify the transmitter, is greatly reduced. In particular, the system and method of the invention allows transmission times to be reduced from about 100 to about 500 times compared to existing system and methods. Moreover, the multiple transceiver time slot arbitration issue present in many existing systems may be resolved by using a listen-before-talk mechanism employed by embodiments of the control unit. This, in turn, may allow for more support platforms to operate within the reception area, and for shorter periods of time in between the distance measurements.

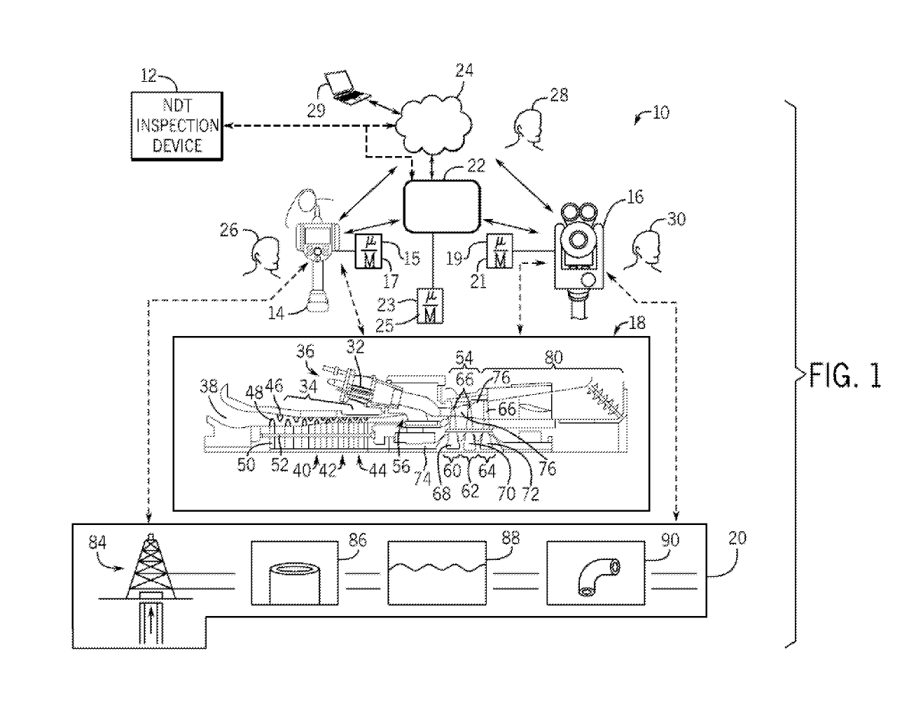

With regard to FIG. 1, the figure is a block diagram showing an embodiment having a distributed NDT system 10. In the depicted embodiment, the distributed NDT system may include one or more NDT inspection devices 12. A suitable NDT inspection device may be classified as one of at least two categories. In one category, depicted in FIG. 1, the NDT inspection devices may be suitable for visually inspecting a variety of equipment and environments. Visual modalities may be further classified by the spectrum in which they work. For example, the device may work in high definition or low definition, in black/white/grey mode or in color, in near infra-red or the visual spectrum. Suitable visual inspection devices may include, for example, charge coupled devices (CCDs), active pixel sensors in complementary metal-oxide-semiconductor (CMOS) or N-type metal-oxide-semiconductor (NMOS, Live MOS) technologies, and the like. In one embodiment, the camera may incorporate a Quanta Image Sensor (QIS). Suitable color detecting sensors may include, for example, one or more Bayer filter sensor, Foveon X3 sensor, or 3CCD, all of which are commercially available. At least some embodiments may use an instant capture system.

These camera systems may further include assisting technologies. Examples of visual assisting technologies may include an image stabilizer. Suitable image stabilizers may include lens shift image stabilizers and other powered stabilization systems, as well as passive digitally manipulatable modes. The system may choose between image stabilization modes based on use parameters—distance between the camera and the target, ambient conditions, relative speeds between the camera and target, and the like. Other suitable assisting technologies may include interpolation algorithms, sharpening, anti-aliasing, anti-moire and compression algorithms. A radome that is transparent to the wavelengths of interest may be employed to protect the sensor systems, and may be part of the housing. A liquid crystal tunable filter (LCTF) may be used with either or both of the visual and non-visual device.

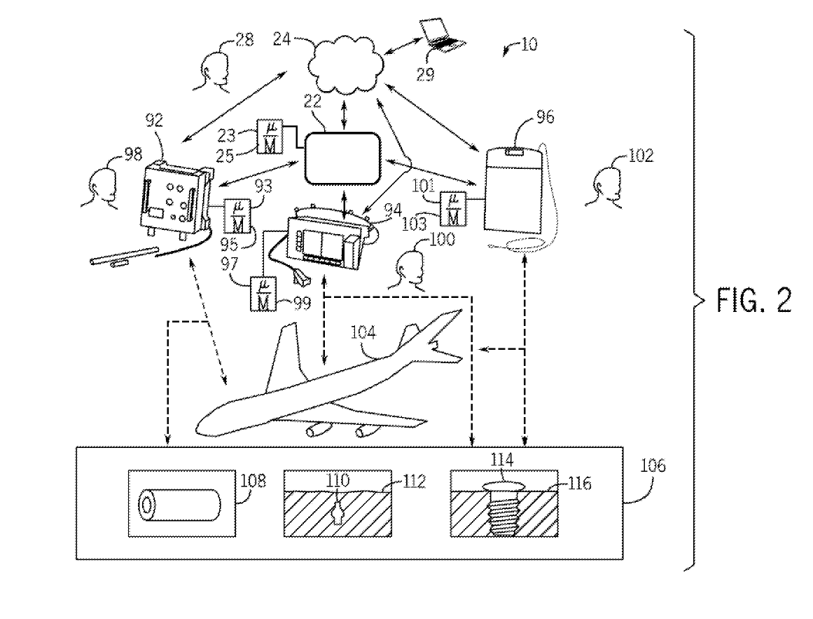

In another category, described in more detail with respect to FIG. 2 below, the NDT inspection devices may include non-visual devices that provide alternatives to visual inspection modalities. Suitable non-visual inspection devices may include x-ray inspection modalities, eddy current inspection modalities, and/or radiographic inspection modalities, laser/photonic modalities, magnetic modalities, acoustic/ultrasound modalities, gamma modalities, thermal modalities, and the like. Of note, the discussion of categories refers to the methodology of collecting the inspection data. Manipulation of the data, digitally or otherwise, may render the non-visual inspection data in visual form suitable for human consumption. Likewise, the collection of visual inspection data may be manipulated in a manner that does not require review by a human user, but which can be directly processed by computer algorithms.

The visual and the non-visual sensing devices may be either active or passive, based at least in part on application specific parameters. An active device may include an emitter paired with a sensor/receiver, whereas the passive device may only include a sensor/receiver. An example of an active system would include an IR sensor, and an IR emitter configured to bounce IR waves off of at least some portion of the target object. RADAR and LiDAR are examples of active remote sensing where the time delay between emission and return is measured, establishing the location, speed and direction of an object.

With reference to selecting sensors for particular applications, the following exemplary guide may be referred to for use alone or in combination with other sensors. In this example, a sensor that is capable of detecting: Blue, 450-515 nanometers (nm) to about 520 nm, may be used for atmospheric measurements and for water imaging, and can reach depths up to 150 feet (50 m) in clear water; Green, 515 nm to about 520-590 to about 600 nm, may be used for imaging vegetation and water structures, up to 90 feet (30 m) in clear water; Red, 600 nm to about 630-680 to about 690 nm, may be used for imaging man-made objects, and objects in water up to 30 feet (9 m) deep, as well as taking readings of soil and vegetation; Near infrared (NIR), 750 nm to about 900 nm, may be used for imaging vegetation; Mid-infrared (MIR), 1550 nm to about 1750 nm, may be used for imaging vegetation, soil moisture content, fires and other thermal events; Far-infrared (FIR), 2080 nm to about 2350 nm, may be used for imaging soil, moisture, geological features, silicates, clays, and fires; Thermal infrared, 10400 nm to about 12500 nm may be emitted from a source located on the instant system, and thereby may use reflected radiation to image geological structures, thermal differences in water currents, fires and thermal events, and for night or underground inspections. Lidar, Radar and related technologies may be useful for mapping terrain, navigating, and for detecting and inspecting various objects. Note that day and night environments may play a factor in sensor selection as sunlight may complicate inspection results. In one embodiment, the system may include multiple sensor packages and may switch between operating modes using different sensor packages based on the target object, as well as environmental parameters. That is, a different package may be used during the day versus at night, above ground vs. below, above water vs. below, raining weather vs. clear, fog vs. clear, and the like. Further, the selection of sensors may be constrained by application specific parameters relating to the type of inspection to be performed.

In the depicted first example category of FIG. 1, suitable NDT inspection devices may include a non-visual inspection device with a housing, such as borescope 14 or borescope system 14 or other inspection tool selected based on the use case. And, the inspection devices may have or be in communication with a controller having one or more processors 15 and a memory 17. The inspection device may be a visual inspection device. A suitable visual inspection device may be a transportable and manipulatable sensor, such as a pan-tilt-zoom (PTZ) camera 16. The visual inspection device may have, or be in communication with, the controller. The controller may have one or more processors 19 and a memory 21 dedicated to visual image processing. In this first category of visual inspection devices that are transportable and manipulatable sensors, a borescope and/or PTZ camera may be used to inspect a target object. An example target object may be turbo machinery 18, and the inspection may be done within a reception zone at a yard, facility or site 20. As illustrated, the borescope and the PTZ camera may be communicatively coupled to a mobile device 22. The mobile device may have, or be in communication with, one or more processors 23 and a memory 25. A suitable mobile device may be, for example, a tablet, a cell phone (e.g., smart phone), a notebook, a laptop, or any other mobile computing device. The use of a tablet may provide balance between screen size, weight, computing power, and battery life. In one embodiment, the mobile device may be the tablet mentioned above that provides for touchscreen input. The mobile device may be communicatively coupled to the NDT inspection devices through a wireless or wired conduit. Suitable wireless conduits may include WiFi (e.g., Institute of Electrical and Electronics Engineers (IEEE) 802.11X), cellular conduits (e.g., high speed packet access (HSPA), HSPA+, long term evolution (LTE), WiMax), near field communications (NFC), Bluetooth, personal area networks (PANs), and the like. The wireless conduits may use a communication protocol, such as TCP/IP, UDP, SCTP, socket layers, and so on. Suitable wired conduits may include proprietary cabling, RJ45 cabling, co-axial cables, fiber optic cables, and the like selected based on application specific parameters.

Additionally or alternatively, the mobile device may be communicatively coupled to the NDT inspection devices, such as the borescope and/or the PTZ camera, through a networked system. A suitable network may include the “cloud” 24. Indeed, the mobile device may use cloud computing and communications techniques (e.g., cloud-computing network), including but not limited to HTTP, HTTPS, TCP/IP, service oriented architecture (SOA) protocols (e.g., simple object access protocol (SOAP), web services description languages (WSDLs)) to interface with the NDT inspection devices from any geographic location, including geographic locations remote from the physical location about to undergo inspection. Further, in one embodiment, the mobile device may provide “hot spot” functionality in which mobile device may provide wireless access point (WAP) functionality suitable for connecting the NDT inspection devices to other systems in the cloud, or connected to the cloud, such as a computing system 29 (e.g., computer, laptop, virtual machine(s) (VM), desktop, workstation). Accordingly, collaboration may be enhanced by providing for multi-party workflows, data gathering, and data analysis. Suitable software is commercially available as Opticks and MicroMSI.

In one embodiment, a support platform may include a sensor packaging having a borescope. One operator may control the support platform to move the platform proximate to a target object through remote control techniques. A borescope operator may physically manipulate the borescope from another location to move it into an inspection orientation. A mobile device operator 28 may use the mobile device to interface with and physically manipulate the borescope at a second location and thereby perform the inspection activity. The second location may be proximate to the first location, or geographically distant from the first location. Likewise, a camera operator 30 may physically operate the PTZ camera orientation from yet another location, while the mobile device operator may perform the inspection operation using the PTZ camera from yet another location, for example by using controls through the mobile device. The locations may be proximate to each other location, or geographically distant from the another of the locations. While such a complex scenario may be unlikely, the flexibility of the instant system to coordinate input from multiply parties of interest and from a plurality of locations may be useful. Assisting technologies, such as time-sensitive networks, may be useful to facilitate such interfacing.

In complex inspection scenarios, such as that described above, it may be desirable to have some of the tasks automated (or semi-autonomous). For example, once the support platform is controlled into position the system may switch from manual control to autonomous control. While in autonomous mode, the support platform may react to stay in a defined location without manual input. This may be useful in water scenarios where water currents may act to push the support platform out of position. In another embodiment, the support platform (rather than remain relatively stationary) may begin a defined movement pattern to, for example, move across and inspect a large area. In one embodiment, the autonomous controls may move the support platform to the reception area and once there, index or aligned on the target object, remain relatively stationary for the inspection or begin the defined movement pattern.

The control actions performed by the operators may be performed by the operator through the mobile device. Additionally, the operator may communicate with the operators by using the devices through techniques such as voice over IP (VOIP), virtual whiteboarding, text messages, and the like. By providing for remote collaboration techniques between the operators, the techniques described herein may provide for enhanced workflows and increase resource efficiencies. Indeed, nondestructive testing processes may leverage the communicative coupling of the with the mobile device, the NDT inspection devices, and external systems coupled to the cloud.

In one mode of operation, the mobile device may be operated by the borescope operator and/or the camera operator to leverage, for example, a larger screen display, more powerful data processing, as well as a variety of interface techniques provided by the mobile device, as described in more detail below. Indeed, the mobile device may be operated alongside or in tandem with the devices by the respective operators. This enhanced flexibility provides for better utilization of resources, including human resources, and improved inspection results.

Whether controlled by the operator, the borescope and/or PTZ camera may be used to visually inspect a wide variety of equipment and facilities. For example, the borescope may be inserted into a plurality of borescope ports and other locations of the turbomachinery 18, to provide for illumination and visual observations of a number of components of the turbomachinery. In the depicted embodiment, the turbomachinery is illustrated as a gas turbine suitable for converting carbonaceous fuel into mechanical power. Other equipment types may be inspected. Suitable equipment may include, for example, one or more compressors, pumps, turbo expanders, wind turbines, hydroturbines, engines, industrial equipment, vehicles, rail cars, cargo containers, vessels, and/or residential equipment. The turbomachinery (e.g., gas turbine) may include a variety of components that may be inspected by the NDT inspection devices described herein.

With the foregoing in mind, it may be beneficial to discuss certain turbomachinery components that may be inspected by using the embodiments disclosed herein. For example, certain components of the turbomachinery depicted in FIG. 1, may be inspected for corrosion, erosion, cracking, leaks, weld inspection, and so on. Mechanical systems may experience mechanical and thermal stresses during operating conditions, which may require periodic inspection of certain components. During operations of the turbomachinery, a fuel such as natural gas or syngas, may be routed to the turbomachinery through one or more fuel nozzles 32 into a combustor 36. Air may enter the turbomachinery through an air intake section 38 and may be compressed by a compressor 34. The compressor may include a series of stages 40, 42, and 44 that compress the air. Each stage may include one or more sets of stationary vanes 46 and blades 48 that rotate to progressively increase the pressure to provide compressed air. The blades may be attached to rotating wheels 50 connected to a shaft 52. The compressed discharge air from the compressor may exit the compressor through a diffuser section 56 and may be directed into the combustor to mix with the fuel. For example, the fuel nozzles may inject a fuel-air mixture into the combustor in a suitable ratio for optimal combustion, emissions, fuel consumption, and power output. In certain embodiments, the turbomachinery may include multiple combustors disposed in an annular arrangement. Each combustor may direct hot combustion gases into a turbine 54.

As depicted, the turbine includes three separate stages 60, 62, and 64 surrounded by a casing 76. Each stage includes a set of blades or buckets 66 coupled to a respective rotor wheel 68, 70, and 72, which are attached to a shaft 74. As the hot combustion gases cause rotation of turbine blades 66, the shaft rotates to drive the compressor and any other suitable load, such as an electrical generator. Eventually, the turbomachinery diffuses and exhausts the combustion gases through an exhaust section 80. Turbine components, such as the nozzles 32, intake 38, compressor, vanes 46, blades 48, wheels 50, shaft 52, diffuser 56, stages 60, 62, and 64, blades 66, shaft 74, casing 76, and exhaust 80, may use the disclosed embodiments, such as the NDT inspection devices 12, to inspect and maintain said components.

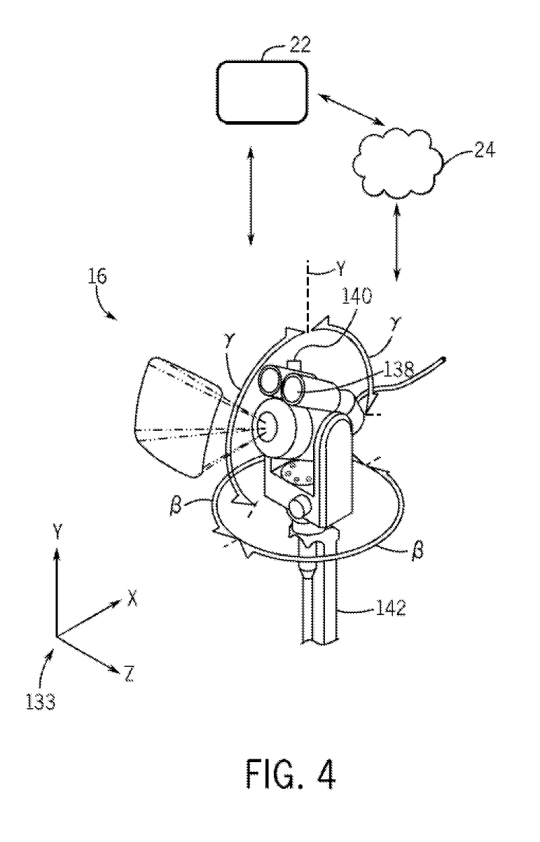

Additionally, or alternatively, the PTZ camera may be disposed at various locations around or inside of the turbomachinery and used to procure visual observations of these locations. The PTZ camera may additionally include one or more lights suitable for illuminating desired locations, and may further include zoom, pan and tilt techniques described in more detail below with respect to FIG. 4, useful for deriving observations around in a variety of difficult to reach areas. The borescope and/or the camera may be additionally used to inspect the facilities. Various equipment such as oil and gas equipment 84, may be inspected visually by using the borescope and/or the PTZ camera. Locations such as the interior of pipes or conduits 86, underwater (or underfluid) locations 88, and difficult to observe locations such as locations having curves or bends 90, may be visually inspected by using the mobile device through the borescope and/or PTZ camera.

Accordingly, the mobile device operator may efficiently inspect the equipment 18, 84 and locations 86, 88, and 90, and share observations in real-time or near real-time with location geographically distant from the inspection areas. Other NDT inspection devices may use the embodiments described herein, such as fiberscopes (e.g., articulating fiberscope, non-articulating fiberscope), and remotely operated vehicles (ROVs), including robotic pipe inspectors and robotic crawlers.

Turning now to FIG. 2, the figure is a block diagram of an embodiment of the distributed NDT system depicting the second category of NDT inspection devices that may be able to provide for alternative inspection data to visual inspection data. For example, the second category of NDT inspection devices may include an eddy current inspection device 92, an ultrasonic inspection device, such as an ultrasonic flaw detector 94, and an x-ray inspection device, such a digital radiography device 96. The eddy current inspection device 92 may include one or more processors 93 and a memory 95. Likewise, the ultrasonic flaw detector 94 may include one or more processors 97 and a memory 99. Similarly, the digital radiography device 96 may include one or more processors 101 and a memory 103. In operation, the eddy current inspection device 92 may be operated by an eddy current operator 98, the ultrasonic flaw detector 94 may be operated by an ultrasonic device operator 100, and the digital radiography device 96 may be operated by a radiography operator 102.

As depicted, the eddy current inspection device 92, the ultrasonic flaw detector 94, and the digital radiography inspection device 96, may be communicatively coupled to the mobile device by using wired or wireless conduits, including the conduits mentioned above with respect to FIG. 1. Additionally, or alternatively, the devices 92, 94, and 96 may be coupled to the mobile device by using the cloud, for example the borescope may be connected to a cellular “hotspot,” and use the hotspot to connect to one or more experts in borescopic inspection and analysis. Accordingly, the mobile device operator 28 may remotely control various aspects of operations of the devices 92, 94, and 96 by using the mobile device, and may collaborate with the operators 98, 100, and 102 through voice (e.g., voice over IP (VOIP)), data sharing (e.g., whiteboarding), providing data analytics, expert support and the like, as described in more detail herein.

Accordingly, it may be possible to enhance the visual observation of various equipment, such as a vehicle system 104 and facilities 106, with x-ray observation modalities, ultrasonic observation modalities, and/or eddy current observation modalities. For example, the interior and the walls of pipes 108 may be inspected for corrosion and/or erosion. Likewise, obstructions or undesired growth inside of the pipes 108 may be detected by using the devices 92, 94, and/or 96. Similarly, fissures or cracks 110 disposed inside of certain ferrous or non-ferrous material 112 may be observed. Additionally, the disposition and viability of parts 114 inserted inside of a component 116 may be verified. Indeed, by using the techniques described herein, improved inspection of equipment and components may be provided. For example, the mobile device may be used to interface with and provide remote control of the inspection devices.

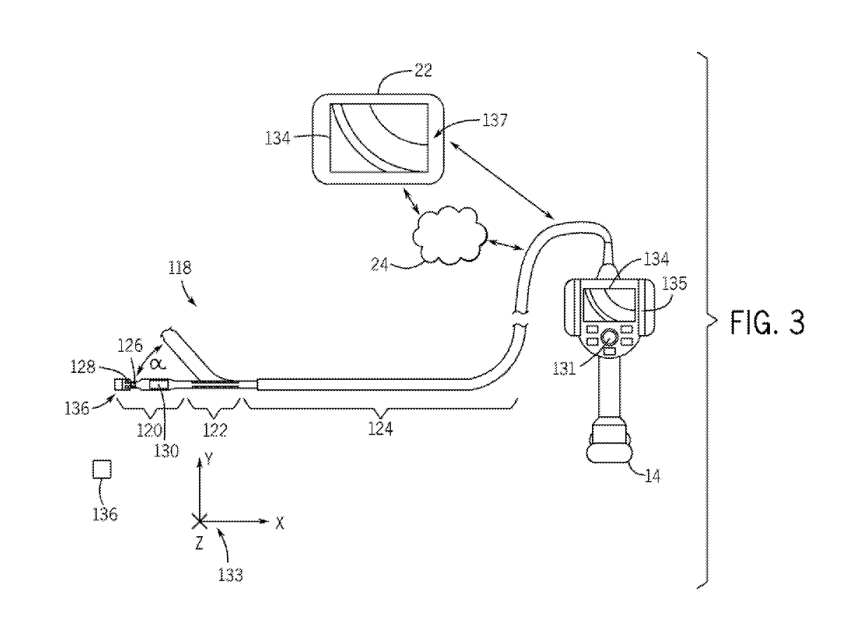

FIG. 3 is a front view of the borescope coupled to the mobile device and the cloud. Accordingly, the borescope may provide data to any number of devices connected to the cloud or inside the cloud. As mentioned above, the mobile device may be used to receive data from the borescope, to remote control the borescope, or a combination thereof. Indeed, the techniques described herein enable, for example, the communication of a variety of data from the borescope to the mobile device, including but not limited to images, video, and sensor measurements, such as temperature, pressure, flow, clearance (e.g., measurement between a stationary component and a rotary component), and distance measurements. Likewise, the mobile device may communicate control instructions, reprogramming instructions, configuration instructions, and the like, as described in more detail below.

As depicted, the borescope includes an insertion tube 118 suitable for insertion into a variety of location, such as inside of the turbomachinery, equipment 84, pipes or conduits 86, underwater locations 88, curves or bends 90, varies locations inside or outside of the vehicle system 104, the interior of pipe 108, and so on. The insertion tube 118 may include a head end section 120, an articulating section 122, and a conduit section 124. In the depicted embodiment, the head end section may include a camera 126, one or more lights 128 (e.g., LEDs), and sensors 130. As mentioned above, the borescope's camera may provide images and video suitable for inspection. The lights may illuminate when the head end is disposed in locations having low light or no light.

During use, the articulating section 122 may be controlled, for example, by the mobile device and/or a physical joystick 131 disposed on the borescope. The articulating sections 122 may steer or “bend” in various dimensions. For example, the articulation section may enable movement of the head end in an X-Y plane, X-Z plane, and/or Y-Z plane of the depicted XYZ axes 133. Indeed, the physical joystick and/or the mobile device may both be used alone or in combination, to provide control actions suitable for disposing the head end at a variety of angles, such as the depicted angle α. In this manner, the borescope head end may be positioned to visually inspect desired locations. The camera 126 may then capture, for example, a video 134, which may be displayed in a screen 135 of the borescope and a screen 137 of the mobile device and may be recorded by the borescope and/or the mobile device. In one embodiment, the screens 135 and 137 may be multi-touchscreens using capacitance techniques, resistive techniques, infrared grid techniques, and the like, to detect the touch of a stylus and/or one or more human fingers. Additionally or alternatively, images and the video data may be transmitted into a networked data repository, such as the cloud.

Other data, including but not limited to sensor data, may additionally be communicated and/or recorded by the borescope. The sensor data may include temperature data, distance data, clearance data (e.g., distance between a rotating and a stationary component), flow data, and so on. In certain embodiments, the borescope may include a plurality of replacement tips 136. For example, the replacement tips may include retrieval tips such as snares, magnetic tips, gripper tips, and the like. The replacement tips may additionally include cleaning and obstruction removal tools, such as wire brushes, wire cutters, and the like. The tips may additionally include tips having differing optical characteristics, such as focal length, stereoscopic views, 3-dimensional (3D) phase views, shadow views, and so on. Additionally or alternatively, the head end may include a removable and replaceable head end. Accordingly, a plurality of head ends may be provided at a variety of diameters, and the insertion tube may be disposed in a number of locations having openings. In one embodiment, the size of the openings may be in a range of from approximately one millimeter to about ten millimeters. In other use cases, the sizes may differ based on the specific needs of that use case. Indeed, a wide variety of equipment and facilities may be inspected, and the data may be shared through the mobile device and/or the cloud.

FIG. 4 is a perspective view of an embodiment of the transportable PTZ camera communicatively coupled to the mobile device and to the cloud. As mentioned above, the mobile device and/or the cloud may remotely manipulate the PTZ camera to position the PTZ camera to view desired equipment and locations. In the depicted example, the PTZ camera may be tilted and rotated about the Y-axis. For example, the PTZ camera may be rotated at an angle β between approximately 0° to 180°, 0° to 270°, 0° to 360°, or more about the Y-axis. Likewise, the PTZ camera may be tilted, for example, about the Y-X plane at an angle γ of approximately 0° to 100°, 0° to 120°, 0° to 150°, or more with respect to the Y-Axis. Lights 138 may be similarly controlled, for example, to active or deactivate, and to increase or decrease a level of illumination (e.g., lux) to a desired value. Sensors 140, such as a laser rangefinder, may be mounted onto the PTZ camera, suitable for measuring distance to certain objects. Other sensors 140 may be used, including long-range temperature sensors (e.g., infrared temperature sensors), pressure sensors, flow sensors, clearance sensors, and so on.

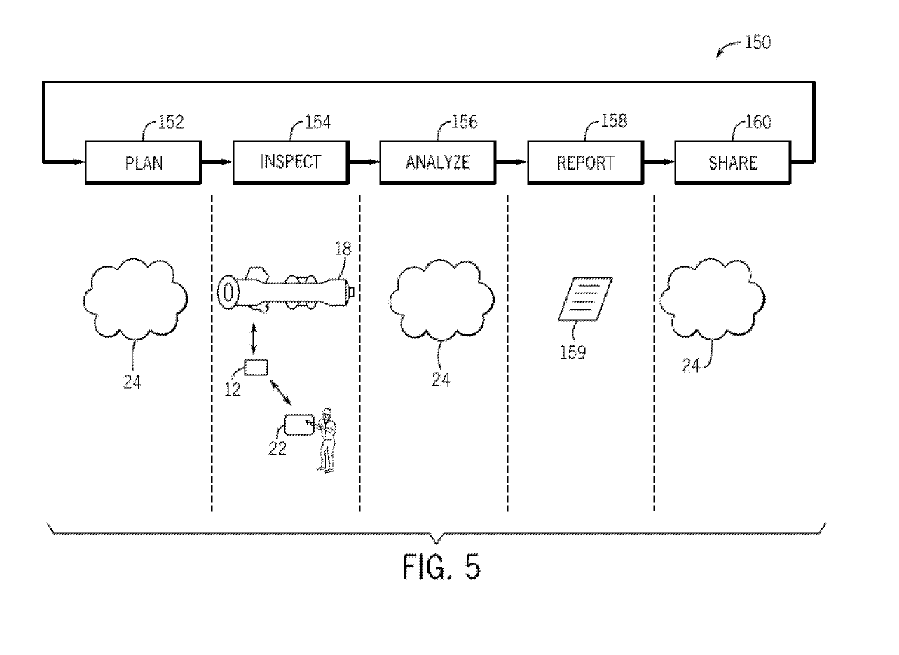

The PTZ camera may be transported to a desired location, for example, by using a shaft 142. The shaft enables the camera operator to move the camera and to position the camera, for example, inside of locations 86, 108, underwater 88, into hazardous (e.g., hazmat) locations, and so on. Additionally, the shaft may be used to more permanently secure the PTZ camera by mounting the shaft onto a permanent or semi-permanent mount. In this manner, the PTZ camera may be transported and/or secured at a desired location. The PTZ camera may then transmit, for example by using wireless techniques, image data, video data, sensor 140 data, and the like, to the mobile device and/or cloud. Accordingly, data received from the PTZ camera may be remotely analyzed and used to determine the condition and suitability of operations for desired equipment and facilities. Indeed, the techniques described herein may provide for a comprehensive inspection and maintenance process suitable for planning, inspecting, analyzing, and/or sharing a variety of data by using the aforementioned devices 12, 14, 16, 22, 92, 94, 96, and the cloud, as described in more detail below with respect to FIG. 5.

FIG. 5 is a flowchart of an embodiment of a process 150 suitable for planning, inspecting, analyzing, and/or sharing a variety of data by using the aforementioned devices 12, 14, 16, 22, 92, 94, 96, and the cloud. Indeed, the techniques described herein may use the devices to enable processes, such as the depicted process 150, to more efficiently support and maintain a variety of equipment. In certain embodiments, the process 150 or portions of the process 150 may be included in non-transitory computer-readable media stored in memory, such as the memory and executable by one or more processors, such as the processors.

In one example, the process may plan (block 152) for inspection and maintenance activities. Data acquired by using one or more devices and others, such as fleet data, from equipment users (e.g., vehicle 104 service companies), and/or equipment manufacturers, may be used to plan (block 152) maintenance and inspection activities, more efficient inspection schedules for machinery, flag certain areas for a more detailed inspection, and so on. The process 150 may then enable the use of a single mode or a multi-modal inspection (block 154) of desired facilities and equipment (e.g., turbomachinery). As mentioned above, the inspection (block 154) may use any one or more of the NDT inspection devices (e.g., borescope, PTZ camera, eddy current inspection device 92, ultrasonic flaw detector 94, digital radiography device 96), thus providing with one or more modes of inspection (e.g., visual, ultrasonic, eddy current, x-ray). In the depicted embodiment, the mobile device may be used to remotely control the NDT inspection devices, to analyze data communicated by the NDT inspection devices, to provide for additional functionality not included in the NDT inspection devices as described in more detail herein, to record data from the NDT inspection devices, and to guide the inspection (block 154), for example, by using menu-driven inspection (MDI) techniques, among others.

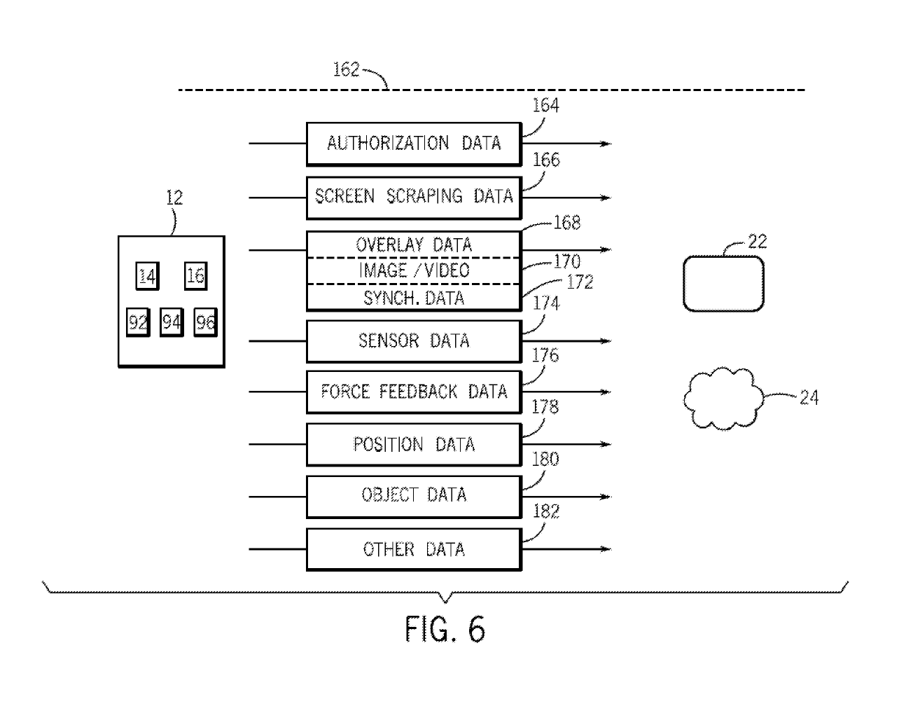

Results of the inspection (block 154), may then be analyzed (block 156), for example, by using the NDT device, by transmitting inspection data to the cloud, by using the mobile device, or a combination thereof. The analysis may include engineering analysis useful in determining remaining life for the facilities and/or equipment, wear and tear, corrosion, erosion, and so forth. The analysis may additionally include operations research (OR) analysis used to provide for more efficient parts replacement schedules, maintenance schedules, equipment utilization schedules, personnel usage schedules, new inspection schedules, and so on. The analysis (block 156) may then be reported (block 158), resulting in one or more reports 159, including reports created in or by using the cloud, detailing the inspection and analysis performed and results obtained. The reports 159 may then be shared (block 160), for example, by using the cloud, the mobile device, and other techniques, such as workflow sharing techniques. In one embodiment, the process 150 may be iterative, thus, the process 150 may iterate back to planning (block 152) after the sharing (block 160) of the reports 159. By providing for embodiments useful in using the devices (e.g., 12, 14, 16, 22, 92, 94, 96) described herein to plan, inspect, analyze, report, and share data, the techniques described herein may enable a more efficient inspection and maintenance of the facilities and the equipment. Indeed, the transfer of multiple categories of data may be provided, as described in more detail below with respect to FIG. 6.

FIG. 6 is a data flow diagram depicting an embodiment of the flow of various data categories originating from the NDT inspection devices and transmitted to the mobile device and/or the cloud. As mentioned above, the NDT inspection devices may use a wireless conduit 162 to transmit the data. Suitable wireless conduits 162 may include WiFi (e.g., 802.11X), cellular conduits (e.g., HSPA, HSPA+, LTE, WiMax), NFC, Bluetooth, PANs, and the like. The wireless conduit 162 may use a variety of communication protocols, such as TCP/IP, UDP, SCTP, socket layers, and so on. In certain embodiments, the wireless conduit 162 may include secure layers, such as SSL, VPN layers, encrypted layers, challenge key authentication layers, token authentication layers, and so on. Accordingly, an authorization data 164 may be used to provide any number of authorization or login information suitable to pair or otherwise authenticate the NDT inspection device to the mobile device and/or the cloud. Additionally, the wireless conduit 162 may dynamically compress data, depending on, for example, currently available bandwidth and latency. The mobile device may then uncompress and display the data. Compression/decompression techniques may include H.261, H.263, H.264, moving picture experts group (MPEG), MPEG-1, MPEG-2, MPEG-3, MPEG-4, DivX, and so on.

In certain modalities (e.g., visual modalities), images and video may be communicated by using certain of the NDT inspection devices. Other modalities may also send video, sensor data, and so on, related to or included in their respective screens. The NDT inspection device may, in addition to capturing images, overlay certain data onto the image, resulting in a more informative view. For example, a borescope tip map may be overlaid on the video, showing an approximation of the disposition of a borescope tip during insertion so as to guide the operator to more accurately position the borescope camera. The overlay tip map may include a grid having four quadrants, and the tip disposition may be displayed as dot in any portion or position inside of the four quadrants. A variety of overlays may be provided, as described in more detail below, including measurement overlays, menu overlays, annotation overlays, and object identification overlays. The image and video data, such as the video 134, may then be displayed, with the overlays displayed on top of the image and video data.

In one embodiment, the overlays, image, and video data may be “screen scraped” from the screen 135 and communicated as screen scrapping data 166. The screen scrapping data 166 may then be displayed on the mobile device and other display devices communicatively coupled to the cloud. Advantageously, the screen scrapping data 166 may be more easily displayed. Indeed, because pixels may include both the image or video and overlays in the same frame, the mobile device may simply display the aforementioned pixels. However, providing the screen scraping data may merge both the images with the overlays, and it may be beneficial to separate the two (or more) data streams. For example, the separate data streams (e.g., image or video stream, overlay stream) may be transmitted approximately simultaneously, thus providing for faster data communications. Additionally, the data streams may be analyzed separately, thus improving data inspection and analysis.

Accordingly, in one embodiment, the image data and overlays may be separated into two or more data streams 168 and 170. The data stream 168 may include only overlays, while the data stream 170 may include images or video. In one embodiment, the images or video 170 may be synchronized with the overlays 168 by using a synchronization signal 172. For example, the synchronization signal may include timing data suitable to match a frame of the data stream 170 with one or more data items included in the overlay stream 168. In yet another embodiment, no synchronization data 172 data may be used. Instead, each frame or image may include a unique ID, and this unique ID may be matched to one or more of the overlay data 168 and used to display the overlay data 168 and the image data together.

The overlay data may include a tip map overlay. For example, a grid having four squares (e.g., quadrant grid) may be displayed, along with a dot or circle representing a tip position. This tip map may thus represent how the tip is being inserted inside of an object. A first quadrant (top right) may represent the tip being inserted into a top right corner looking down axially into the object, a second quadrant (top left) may represent the tip being inserted into a left right corner looking down axially, a third quadrant (bottom left) may represent the tip being inserted into a bottom left corner, and a fourth quadrant (bottom right) may represent the tip being inserted into a bottom right corner. Accordingly, the borescope operator may more easily guide insertion of the tip.

Overlay data may include measurement overlays. For example, measurement such as length, point to line, depth, area, multi-segment line, distance, skew, and circle gauge may be provided by enabling the user to overlay one or more cursor crosses (e.g., “+”) on top of an image. In one embodiment, a stereo probe measurement tip or a shadow probe measurement tip may be provided, suitable for measurements inside of objects, including stereoscopic measurements and/or by projecting a shadow onto an object. By placing a plurality of cursor icons (e.g., cursor crosses) over an image, the measurements may be derived using stereoscopic techniques. For example, placing two cursors icons may provide for a linear point-to-point measurement (e.g., length). Placing three cursor icons may provide for a perpendicular distance from a point to a line (e.g., point to line). Placing four cursor icons may provide for a perpendicular distance between a surface (derived by using three cursors) and a point (the fourth cursor) above or below the surface (e.g., depth). Placing three or more cursors around a feature or defect may then give an approximate area of the surface contained inside the cursors. Placing three or more cursors may also enable a length of a multi-segment line following each cursor.

Likewise, by projecting a shadow, the measurements may be derived based on illumination and resulting shadows. Accordingly, by positioning the shadow across the measurement area, then placing two cursors as close as possible to the shadow at furthermost points of a desired measurement may result in the derivation of the distance between the points. Placing the shadow across the measurement area, and then placing cursors at edges (e.g., illuminated edges) of the desired measurement area approximately to the center of a horizontal shadow may result in a skew measurement, otherwise defined as a linear (point-to-point) measurement on a surface that is not perpendicular to the borescope 14 view. This may be useful when a vertical shadow is not obtainable.

Similarly, positioning a shadow across the measurement area, and then placing one cursor on a raised surface and a second cursor on a recessed surface may result in the derivation of depth, or a distance between a surface and a point above or below the surface. Positioning the shadow near the measurement area, and then placing a circle (e.g., circle cursor of user selectable diameter, also referred to as circle gauge) close to the shadow and over a defect may then derive the approximate diameter, circumference, and/or area of the defect.

Overlay data 168 may also include annotation data. For example, text and graphics (e.g. arrow pointers, crosses, geometric shapes) may be overlaid on top of an image to annotate certain features, such as “surface crack.” Additionally, audio may be captured by the NDT inspection device, and provided as an audio overlay. For example, a voice annotation, sounds of the equipment undergoing inspection, and so on, may be overlaid on an image or video as audio. The overlay data 168 received by the mobile device and/or cloud may then be rendered by a variety of techniques. For example, HTMLS or other markup languages may be used to display the overlay data. In one embodiment, the mobile device and/or cloud may provide for a first user interface different from a second user interface provided by the NDT device. Accordingly, the overlay data 168 may be simplified and only send basic information. For example, in the case of the tip map, the overlay data 168 may simply include X and Y data correlative to the location of the tip, and the first user interface may then use the X and Y data to visually display the tip on a grid.

Additional sensor data 174 may be communicated. For example, data from the sensors such as x-ray sensor data, eddy current sensor data, and the like may be communicated. In certain embodiments, the sensor data may be synchronized with the overlay data, for example, overlay tip maps may be displayed alongside with temperature information, pressure information, flow information, clearance, and so on. Likewise, the sensor data may be displayed alongside the image or video data.

In certain embodiments, force feedback or haptic feedback data may be communicated. The force feedback data may include, for example, data related to the borescope tip abutting or contacting against a structure, vibrations felt by the tip or vibration sensors, force related to flows, temperatures, clearances, pressures, and the like. The mobile device may include, for example, a tactile layer having fluid-filled microchannels, which, based on the force feedback data, may alter fluid pressure and/or redirect fluid in response. Indeed, the techniques describe herein, may provide for responses actuated by the mobile device suitable for representing sensor data and other data in the conduit as tactile forces.

The NDT devices may communicate position data. For example, the position data may include locations of the NDT devices in relation to equipment and/or facilities. For example, techniques such as indoor GPS, RFID, triangulation (e.g., WiFi triangulation, radio triangulation) may be used to determine the position 178 of the devices. Object data 180 may include data related to the object under inspection. For example, the object data may include identifying information (e.g., serial numbers), observations on equipment condition, annotations (textual annotations, voice annotations), and so on. Other types of data 182 may be used. Other data types may include menu-driven inspection data, which when used, provides a set of pre-defined “tags” that can be applied as text annotations and metadata. These tags may include location information (e.g., 1s^{t} stage HP compressor) or indications (e.g., foreign object damage) related to the object undergoing inspection. Other data types may include remote file system data, in which the mobile device may view and manipulate files and file constructs (e.g., folders, subfolders) of data located in the memory of the NDT inspection device. Accordingly, files may be transferred to the mobile device and cloud, edited and transferred back into the memory.

### Inspection Management

It may be beneficial to provide an overview of inspection data, such that inspection management may be more conveniently implemented. For example, in some embodiments, inspection management graphical user interfaces may present inspection information in a manner that expedites scheduling of new inspection based upon inspector availability, asset outages, inspection equipment availability, etc. By enabling these graphical user interfaces, inspection managers may be apprised of additional information that has traditionally been difficult to obtain.

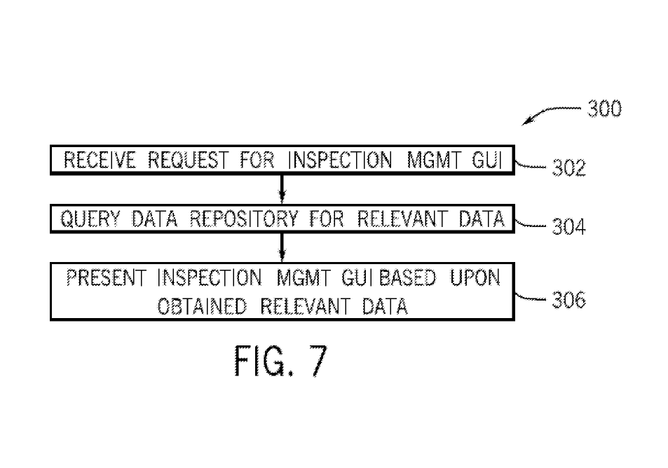

FIG. 7 is a flowchart illustrating a process 300 for providing real-time inspection management data in a graphical user interface, in accordance with an embodiment. The process 300 begins by receiving a request for an inspection management graphical user interface (block 302). For instance, an inspector or other operation may desire to: view the inspector's scheduled inspections, view planned asset outages, view information relating to inspection device availability, start a remote collaboration session with an inspector at a local inspection site, view site inspection status, etc. The inspector may request a GUI providing the desired information via a computer by accessing an application, website, etc.

A data repository may be accessed and queried for relevant inspection data pertaining to the request described in block 302 (block 304). Data in the data repository may be provided by a data-provider, such as a cloud-based data provider, that is communicatively coupled to the computer and/or other device (such as an inspection instrument) providing the GUI. In some embodiments, the data repository may store inspection management data, such as: historical inspection data, inspection schedules for a given asset that will be inspected, inspection schedules for particular inspectors, asset location, inspector location, etc. For example, an inspector may provide data to the data-provider via an inspection instrument, such as inspection status, inspection results, etc. Subsequently, the computer or other device may obtain the data from the data-provider. Using the provided inspection data, the computer or other device may provide an inspection management GUI (block 306), enabling an operator to efficiently manage numerous inspections across a multitude of geographies.

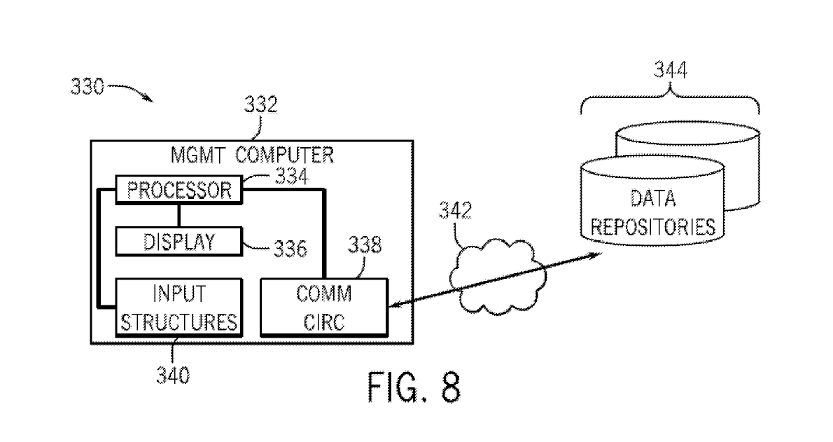

FIG. 8 is a schematic diagram of an inspection management system 330 enabled to provide an inspection management GUI, in accordance with an embodiment. The inspection management system 330 may include a management computer 332 or other device, such as an inspection instrument, that includes one or more processors 334, a display 336, communications circuitry 338 and/or input structures 340. The processor(s) 334 may detect a desire to present an inspection management GUI to facilitate inspection management. For example, the processor(s) 334 may interpret such a desire based upon an operator's interaction with the input structures 340. Based upon the determined request, the processor(s) 334 may provide a data request to a data provider (e.g., cloud-based data provider 342). The data provider may access one or more data repositories 344 to obtain particular inspection data useful for populating the inspection management GUI. The data repositories 344 may include, for example, data from a manufacturer of the inspection device and/or inspected asset, historical inspection data provided from previous inspections, inspection scheduling data, and/or inspection status data. For instance, this data may be provided by devices the inspection environment to the data repositories 344. For example, an inspection instrument may provide inspection status updates to the data repositories 344 as an inspection progresses. Upon receiving the inspection data from the data provider, the management computer 332 or other device may present the GUI via the display 336 or other human machine interface, such as a simulated display device served up in a web browser, computer application, and/or inspection device interface. In some instances, the GUI may present the data from data repositories 344 in real-time.

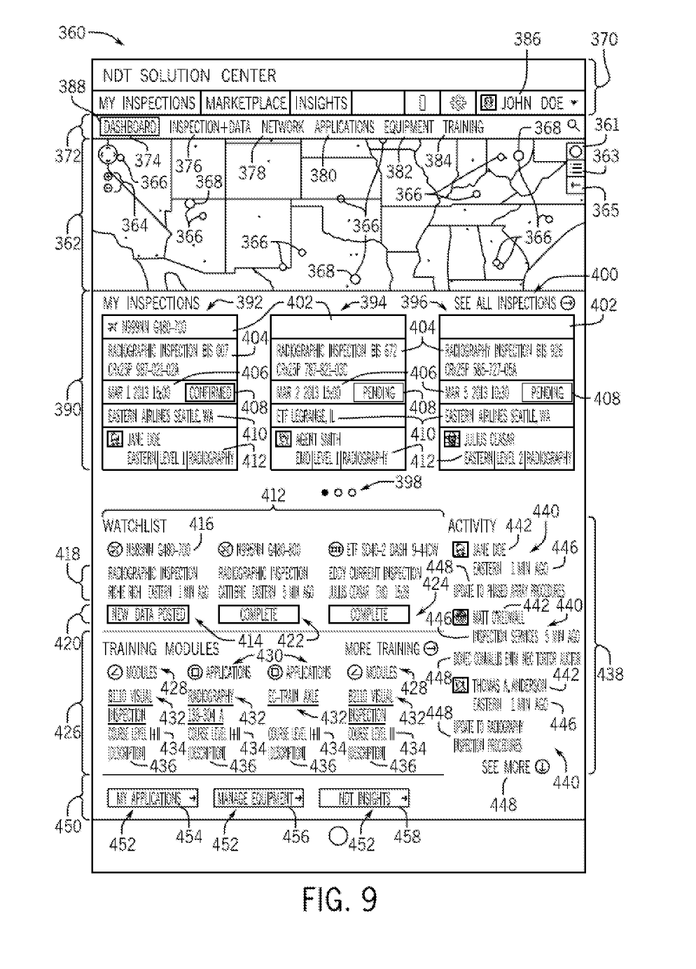

In a particular graphical user interface, the inventive system may be useful in managing inspections. FIG. 9 is an example of an inspection management system graphical user interface (GUI) 360 useful for managing the inspection of assets across multiple geographies, in accordance with an embodiment. When the atlas view icon 361 is selected, the GUI 360 includes an atlas view, providing a geographical representation of inspection data using a digitized map 362. The GUI 360 is not limited to an atlas view. When the list icon 363 is selected, a listing of inspection data is provided. In the current view, however, the atlas icon 361 is selected. The digitized map 362 illustrates a country-level view (e.g., the United States of America). In some embodiments, however, the scope of the digitized map 362 may change. For example, in the provided embodiment, zoom buttons 364 may modify the scope of the map 362. When the zoom is increased, the scope may be reduced (e.g., to a portion of the country-level view). When the zoom is decreased, the scope may increase (e.g., to a multi-country view and/or a global view). By enabling a dynamic scope adjustment within the GUI 360, an inspector may specify a particular region of inspection management that is desired by the inspector. The map 362 may include inspection data icons 366, which may provide an indication of certain inspection data at a particular geography. For example, the placement of the data icons 366 may represent a location of an inspection asset, inspection instrument, inspector, etc. The icons 366 may vary to illustrate a variety of characteristics of the inspection data. For example, the icons 366 may vary in color, size, transparency, etc. Further, as illustrated, one variance of the icons 366 may be to present a border 368 around the icons 366, further indicating a particular attribute of the inspection data. In some embodiments, one icon 366 variation (e.g., a color variation, size variation and/or border variation) may indicate an asset type. For example, gas turbines might be represented in one size icon 366 and airplanes may be represented in a differently sized icon 366. Further, a variation in the icons 366 may signify other differences regarding the assets (e.g., icons 366 representing Manufacturer A's airplanes may be sized differently than icons 366 for Manufacturer B's airplanes). Icon 366 variance may also represent a change in asset status (e.g., online or offline), inspection status (e.g., emergency inspection, scheduled inspection, inspection in progress, recently completed inspection, etc.) and/or inspection instrument type (e.g., borescope, eddy current, X-ray). Further, one or more of these variations may represent personnel-related information. For example, Inspector A's inspections may be represented in blue and Inspector B's inspections may be represented in red. Further, different icon 366 borders 368 may be used to signify that a particular inspector certification and/or certification level is needed to complete an inspection. By using icon 366 variances in a geographical view, an inspection planning team may quickly and accurately assess the inspection environment. Accordingly, the planning team may observe various inspection environment attributes, such as outages, inspection equipment availability, inspector availability, inspection status, etc., and make any inspection planning changes accordingly.

Depending on the view selected in the GUI 360, the icons 366 and the variances of the icons 366 may indicate different inspection data and inspection data characteristics. In some embodiments, the GUI 360 may include a toolbar 370 with a view selector 372 that enables an operator to select one of many views for the GUI 360, each with icons 366 representing different inspection data and/or inspection data attributes. In alternative embodiments, such as embodiments where the GUI 360 is provided in a display with a more limiting screen size (e.g., a display of an inspection instrument), only one or a subset of the many views may be available. In the current embodiment, the views include: a dashboard view 374, an inspections and data view 376, a network view 378, an application view 380, an equipment view 382, and a training view 384. These views may provide particular inspection data related to a particular selected item. For instance, in the current example, the GUI 360 is focused on data for a supervisor “John Galt,” as indicated by the item selector 386. By selecting an item in the item selector 386, the operator may choose a particular item (e.g., an inspector, operator, asset, location, time interval, and/or geography) with which to obtain inspection data for. Because the item selector 386 is set to supervisor “John Galt” in the current example, inspection data associated with “John Galt” will be presented in the GUI 360. The dashboard view 374 may provide an overview of inspection data. The inspections and data view 376 may provide a listing of performed inspections and the collected data obtained during those inspections. The network view 378 may provide network statistics. The applications view 380 may provide a list of available applications associated with the selected item. The equipment view 382 may provide details regarding the inspection devices and/or the assets that undergo inspection associated with a selected item. The training view 384 may provide training modules associated with a selected item.

As indicated by a highlighted icon 388, the current view is the dashboard view 374. The dashboard view 374 may provide an overview of inspection data available for the item selected in the item selector 386. For instance, in the current example, an overview of inspection data for “John Galt” is provided. In some embodiments, an assigned inspection section 390, which may provide details about upcoming inspections assigned to “John Galt.” In the current example, the assigned inspection section 390 provides separate inspection boxes 392, 394, and 396 for the top three inspections assigned to the supervisor. Additional assigned inspections may be displayed by selection one of the additional information icons 398 or the “See All Inspections” option 400. This section is not limited to showing the top 3 inspections, but indeed, in alternative embodiments may show any number of top items or a listing of all assigned inspections. Further, in some embodiments, a grid or other display method may be used in lieu of the inspection boxes 392, 394, and 396. The provided example is not intended to limit the design, but instead is provided to facilitate discussion of the GUI 360.

The assigned inspection section 390 may provide details regarding the assigned inspections. For example, inspection boxes 392, 394, and 396 each provide an identity 402 of the asset to be inspected, particular inspection devices to be used in the inspection 404, a date and/or time planned for the inspection 406, the scheduling status 408, a location of the inspection 410, and identifying information for other resources associated with the inspection (e.g., an assigned inspector 386).

In an embodiment of the GUI 360 provided on an inspection instrument, for instance, inspection tasks assigned to inspector and/or inspection instrument may be provided. For example, as described above, one or more maps (e.g., geographical and/or site-based) and/or overlays may provide asset location information for one or more assets scheduled to be inspected (or previously inspected) by the inspector and/or inspection instrument. Accordingly, the inspector may stay apprised of assigned inspection tasks, which may, for example, be assigned remotely by an inspection planning team. The maps and/or overlays may guide the inspector from the current location to a location of the next planned inspection. Accordingly, the inspector may efficiently move between inspections, being provided guidance along the way

In some embodiments, the dashboard view 374 may also include a watchlist section 412, which may provide an operator with particular actions assigned to the operator, based upon, for example, inspection data changes. For example, a supervisor may wish to remain apprised when new data is captured for an inspection the supervisor is assigned to, such that the operator may analyze the data. Accordingly, the watchlist section 412 may present a watchlist item 414 when new data is provided to a data repository. In the current embodiment, the watchlist item 414 includes an item identifier 416 (e.g., an inspection identifier for the inspection with a data change), characteristic data 418 relating to the item (e.g., the type of inspection, the inspector who performed the inspection, the location of the inspection, when the inspection was performed, etc.). The watchlist item 414 also includes a status indicator 420, which may provide an indication regarding why the item 414 is in the watchlist section 412 (e.g., because “new data posted”). Watchlist items 422 and 424 also include an item identifier 416, characteristic data 418, and a status indicator 420, both indicating that an inspection has been completed.

A training section 426 may also be included in the GUI 360. The training section 426 may include information regarding any training modules and/or applications associated with a selected item. For example, the provided training module items 428 and/or application items 430 are associated with modules and/or applications that “John Galt” may be interested in, such as training modules and/or applications appropriate for “John Galt” based upon course level, subject matter, scheduled inspections, and the like. The training module items 428 and/or application items 430 may provide links 432 to download the actual modules and/or applications. Further, a course level 434 and summary 436 associated with these items may be provided.

Further, operators may desire to remain apprised of activity within the inspection environment, even when no inspection-related tasks are assigned to the operator regarding the activity. An activity section 438 may be provided in the GUI 360 to provide such information. The activity section 438 may provide activity items 440, representing inspection-related activities that are occurring in the inspection environment, as determined based upon data provided from the data repositories. The activity items 440 may include identifying information relating to the item performing the activity 442 (e.g., an operator and/or the operator's employer), where the activity took place 444, and/or when the activity took place 446. Further a description 448 of the activity may be provided. In the current embodiment, the three most recent activities are shown. Additional activities may be shown by selecting the “see more” option 448.

A function section 450 may also be provided. The function section 450 may provide options 452, facilitating inspection management. For example, in the current embodiment, the “My Applications” option 454 may present each of the downloaded applications associated with a currently logged-in user. The “Manage Equipment” option 456 may be used to present management options for assets and/or inspection devices associated with the user. In some embodiments, these options many include the ability to associate new equipment with a user. The “NDT Insights” option 458 may provide access to online analysis and reporting tools for NDT data.

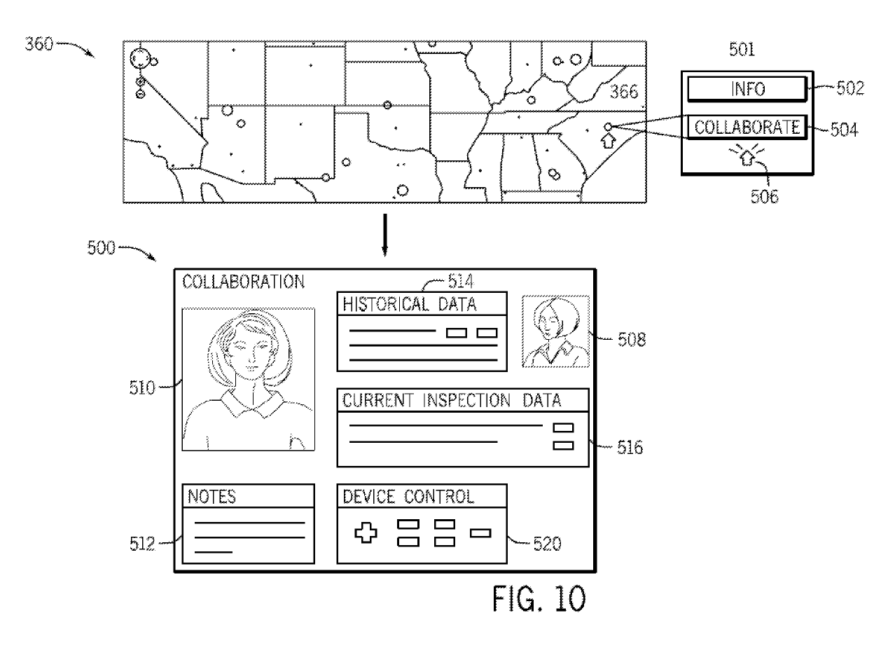

Remote collaboration between operators may also be facilitated using a GUI. FIG. 10 is an example of a collaboration session GUI 500 initiated from the GUI 360, in accordance with an embodiment. For example, when a user hovers over an icon 366 of the GUI 360, a menu 501 may be provided, detailing specific inspection data 502 relating to that icon 366. Further, a collaboration option 504 may be presented as an option when remote collaboration is possible (e.g., when an on-site inspector is equipped with inspection equipment enabled with remote collaboration capabilities). Upon selecting the collaboration option 504, as indicated by arrow icon 506, the GUI 500 is presented. The GUI 500 may include a self-view window 508, enabling an operator to see a self-representation (e.g., an avatar image or live video feed) provided to the remote inspector. Further, a video conferencing window 510 may provide a representation (e.g., an avatar image or live video feed) of the remote inspector. During the collaboration session facilitated by the GUI 500, the operator and remote inspector may initiate an audio and/or video conference, may share data with one another, may share control and/or access to inspection equipment, may provide a virtual representation of the inspection device in a remote location, etc. For instance, in the current example, the GUI includes a notes section 512 that may be shared by the remote inspector to the operator. The notes section may include text, images, audio, and/or video that the remote inspector has created. Further, the operator may annotate and/or create additional notes via user input structures coupled with the GUI. Further, in some embodiments, the GUI may generate a virtual representation of the inspection device display output presented in the field. For example, as discussed above regarding FIG. 3, video 134 may be displayed in a screen 135 of the borescope. This video (and any other information displayed in the screen) may be presented in the GUI, enabling a remote operator to observe the borescope data.

Inspection data may also be presented in the GUI. For example, the collaboration session may be facilitated by enabling data review by both the remote inspector and the operator. Accordingly, a historical data section 514 may provide historical inspection data associated with the current collaboration topic, as specified by the remote inspector and/or the operator. Further, any current inspection data 516 relating to the current collaboration topic may also be presented in the GUI. The historical data and the current inspection data may include text, images, audio, and/or video.

Additionally, when the operator has proper access rights, a device control interface 520 may be provided. The device control interface may enable an operator to remotely control inspection equipment. For example, the device control interface may enable an operator to remotely calibrate an inspection equipment (e.g., borescope, eddy current, X-ray, ultrasound, etc.), collect information from the inspection equipment, control the inspection equipment, etc.

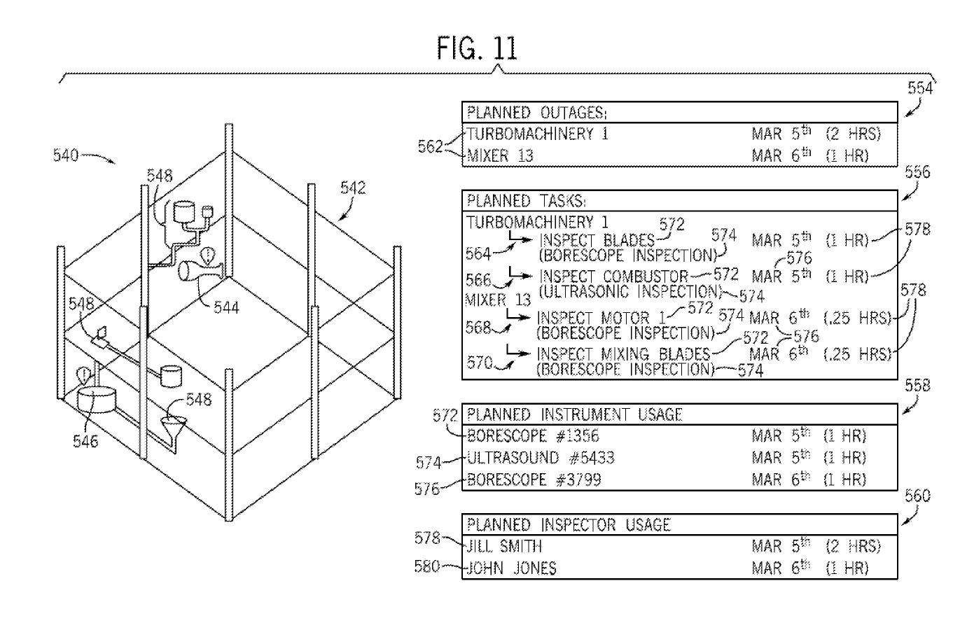

FIG. 11 is an alternative inspection management GUI 540, in accordance with an embodiment. As previously mentioned, the inspection management graphical user interfaces (e.g., GUI) may include a facility layout 542. In the current example, the facility layout represents a view of a multi-floored plant with various assets placed throughout the plant. For example, the plant contains a piece of turbo-machinery, represented by the turbo-machinery icon 544. Further, a mixer is represented by the icon 546. Various other assets may be represented by one or more icons 548.

A variety of planned activities relating to inspection may be provided in the GUI. For example, planned asset outages may be provided in a ‘planned outages’ section 554. Planned tasks (e.g., items to be completed on a particular asset or using a particular piece of inspection equipment) may be provided in a ‘planned tasks’ section 556. Planned usage for inspection equipment may be provided in a planned equipment usage section 558 and planned inspector usage or other operator usage may be provided in a planned inspector or other operator usage section 560.

In the current example, inspections may be planned for turbo-machinery1 on March 5^{th} and Mixer 13 on March 6^{th}. The inspections may be scheduled with durations of 2 hours and 1 hour, respectively. Accordingly, the planned outages section may include planned outage notifications 562, providing notice of the planned outages and the planned outage durations based upon the inspection schedule.

The planned tasks section may provide tasks that are planned for assets within the plant. For example, as previously mentioned, in the current example an inspection is planned for a particular date on an asset identified as Turbo-machinery1. Accordingly, tasks associated with this inspection are populated in the planned tasks section. Specifically, a blade inspection task 564 and a combustor inspection task 566 is associated with Turbo-machinery1 in the planned tasks section. Further the tasks associated with the Mixer 13 inspection are populated in the planned tasks section. Specifically, a “motor 1” inspection task 568 and a mixing blade inspection task 570 are associated with Mixer 13 in the planned tasks section. Each of the tasks may include, for example, an identifier 572 that identifies the task, other details relating to the task 574 (e.g., the type of equipment needed for the inspection), a scheduled date for the inspection 576, and/or a planned duration for the task 578.

The planned inspection device usage section may also be updated based upon the inspection schedule. For example, the turbo-machinery1 inspection on the appropriate date may utilize a borescope and ultrasonic equipment, each for a duration of 1 hour. Accordingly, device items provide notification of a particular borescope and ultrasound equipment that are planned to be used in the inspection, respectively. Further device item 576 provides notice of a particular borescope that will be used for the Mixer 13 inspection on a date subsequent to the earlier activity. By providing the planned inspection device usage schedule, an operator may more conveniently discern available devices for additional inspections, and thus, may enable the operator to more efficiently schedule additional inspections based upon device availability.

The planned inspector (or another operator) usage section may be convenient for planning inspections. This section enables an operator to see which inspectors are available and/or unavailable for performing inspections. In the current example, Jill Smith is scheduled to conduct the turbo-machinery1 inspection on March 5^{th} and John Jones is scheduled to conduct the Mixer 13 inspection on March 6^{th}. Accordingly, inspector usage items populate in the planned inspector usage section. These items may provide an inspection date and/or time as well as duration, thus enabling an operator (e.g., an inspection planner to more efficiently plan future inspections).

The inspection management graphical user interfaces may efficiently present inspection data to an inspection manager. Accordingly, the manager may make more-informed inspection management decisions, based upon resource availability, asset availability, and the like. Additionally, inventive subject matter disclosed herein relates to inspection planning, execution, and reporting. Moreover, the subject matter disclosed herein may provide reference materials during an inspection, which may facilitate the inspection itself.

It may be beneficial to provide supplemental data based upon progress of an inspection. The supplemental data may aid in conducting a proper inspection. For example, in some embodiments, the supplemental data may include reference information provided by a manufacturer of the inspection equipment used in the inspection (e.g., a borescope, ultrasound probe, etc.). Further, reference information may be provided from a manufacturer of the object being inspected (e.g., a turbine component or a vehicle system). In some embodiments, historical inspection data or data relating to previous inspections may be provided as supplemental data.

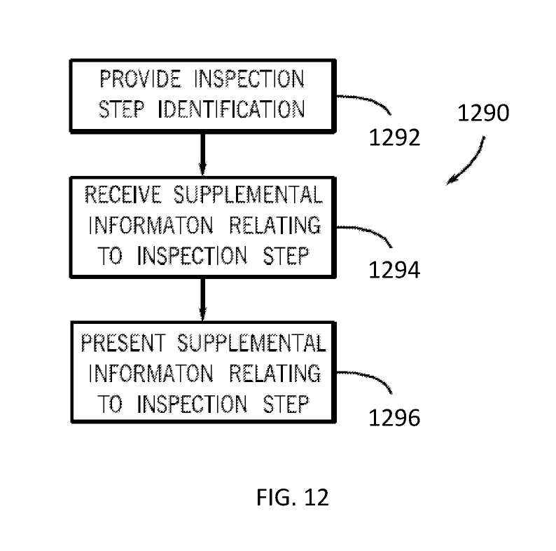

FIG. 12 is a flowchart illustrating a process 1290 for providing reference information during an inspection, in accordance with an embodiment. The process begins by obtaining and providing inspection step identification to a data service provider (block 1292). For example, a piece of inspection equipment may determine a particular step of an inspection that is currently being performed. Suitable inspection equipment may include inspection tools and devices used to observe and/or collect inspection data during the inspection process. Examples of inspection equipment may include NDT devices. Suitable NDT devices may include one or more of a PTZ camera, an X-ray device, an eddy current device, and the like. A controller that is communicatively couplable to the inspection equipment may include computers or other data processers that execute machine-readable instructions relating to inspection-related tasks. These tasks may include providing relevant supplemental data to an inspector and/or recording and/or storing data obtained from inspection tools, and the like. While the supplemental data may include inspection-related data, the supplemental data is not limited to such data. The supplemental data may include any data that is relevant to an inspection. For example, an input oil pressure and/or temperature may be useful in determining the origin of a crack found during an inspection of a target object, thus, because this information is relevant to the inspection, it may be included in the supplemental data.

An inspection may involve a number of steps. Prior to the inspection, there may be an introductory step (e.g., step 0) that identifies details of the inspection such as the object that is to be inspected, any particular portion of the object that is to be inspected, the type of inspection, the equipment to be used during the inspection, any required or useful probes, required or useful training and/or certifications of the inspector, etc. Prior to, during, or upon completion of a particular step (e.g., the first actual step of the inspection), supplemental data may be useful. For example, instructional aides may provide an explanation of proper techniques for obtaining data using an inspection tool.

The current step of the inspection may be determined via a user entry in the inspection equipment and/or may be automatically obtained based upon logic provided in the inspection equipment and/or data provided to the inspection equipment. For example, the inspection equipment may include menu-driven inspection (MDI), which provides step-by-step instructions for inspection, annotation, and so on. As steps are completed during the MDI process, the inspection equipment may determine the next step in the inspection process. In alternative embodiments, the inspection steps may be determined based upon a user input, based upon a position and/or location of the inspection equipment, a time-based inspection schedule, or any other manner that identifies the inspection step.

Once the inspection step is determined, supplemental data relevant to the inspection step may be obtained (block 1294). For example, the supplemental data may include data relating to the object that is being inspected, relating to the inspection equipment, and/or historical inspection data. Further, the supplemental data may include pre-processed data provided from any source, either remote or local to the inspection environment. This supplemental data may be used, for example, to educate an inspector that is completing inspection steps, provide additional analysis of data captured during an inspection step, provide alerts, etc. In some embodiments, data repositories containing supplemental data may be polled based upon an identifier of the determined current step. Further, in certain embodiments, sensors, such as temperature sensors, pressure sensors, motion sensors, and the like may provide supplemental data relevant to an inspection, and thus may be included in the supplemental data. In other embodiments, external data sources may be reviewed for supplemental data—such as weather data, calendar data, environmental data, and the like.

Once the supplemental data is obtained, the data may be presented (block 1296). In some embodiments, the supplemental data may be provided via a human machine interface. For example, images and/or text associated with the supplemental data may be displayed via an electronic display. Audio may be audibly presented via speakers. Further, video data may be played back through a display and/or speakers. Further, haptic technology may provide tactile or touch sensations representative of the supplemental data. For example, a mapping of the surface roughness or profile of the target object may be captured, and then transmitted to the HMI. The HMI may recreate the target object's surface profile so that an operator can experience it by touching.

In some embodiments, the data may be presented to one or more processors for further processing. For example, in one embodiment, supplemental data may include historical images gathered during prior inspections. These historical images may be presented to a processor that runs an algorithm that measures crack progression from the historical images to the currently collected inspection data. This algorithm might, for example, determine a remaining useful life of the asset. Presenting the supplemental data, either for consumption by an operator and/or further processing, may enable more accurate inspections and/or provide a more detailed understanding of an inspection by providing step-specific supplemental data that may aid in accurately completing inspection steps and/or analyzing data obtained during these inspection steps. The supplemental data may be appended to the historical images. The system may present time sequenced images of a particular aspect of the target object. From that, a machine analysis (or by human observation) may determine a rate of change for a particular feature of the target object. Further, a projection of a future state of the target object may be made.

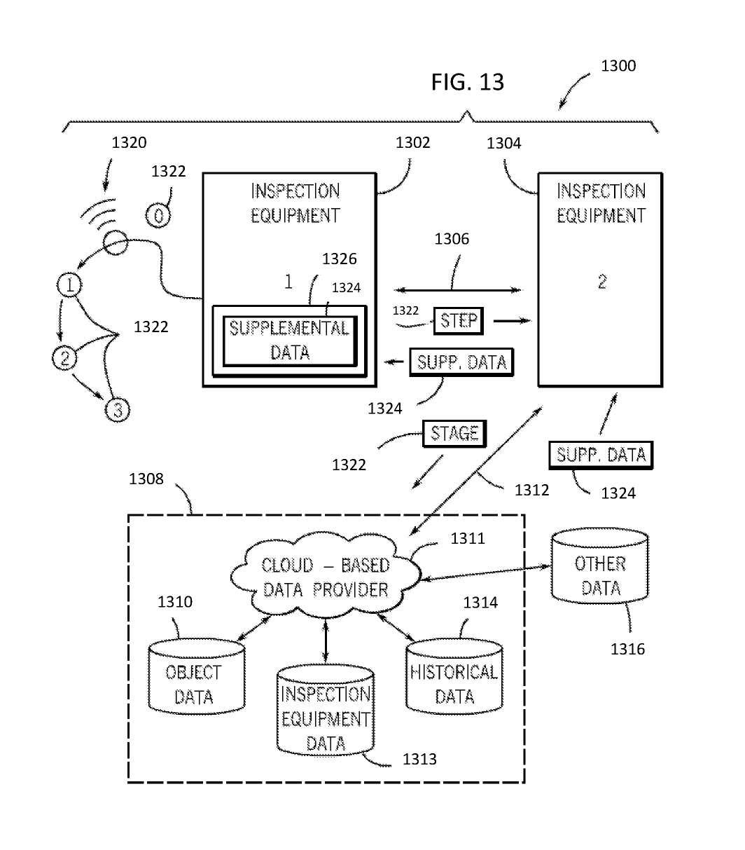

FIG. 13 is a schematic diagram of an inspection system 1300 that provides step-specific supplemental data, in accordance with an embodiment. As illustrated, one or more pieces of inspection equipment (e.g., “Inspection Equipment 1” 1302 and “Inspection Equipment 2” 1304) may be communicatively coupled, as illustrated by the communication connection arrow 1306. For example, the inspection equipment may be connected via a wired or wireless communication network, such as an Ethernet network, Bluetooth network, or WIFI network.

One or more of the pieces of inspection equipment may be communicatively coupled to data provider services 1308 that are enabled to provide pertinent data relevant to an inspection step to the connected inspection equipment. For instance, in the current example, “Inspection Equipment 2”, which may be a computer, is configured to provide object data 1310, relating to the target object being inspected and/or inspection equipment data, relating to the inspection equipment being used, to a data manager 1311, as illustrated by the data connection arrow 1312. In one embodiment, the data manager is cloud-based.

The data provider services may include repositories for inspection-relevant data 1313; and/or historical inspection data 1314, relating to previous data collect during inspections. Further, the data provider services may retrieve data relevant to an inspection from one or more external data repositories 1316. Such repositories may provide training information, reference information, historical trends, comparison data from other equipment or other fleets of equipment, and the like.

As mentioned above, an inspection of an object may be quite complex, having a number of steps. For example, an inspection process 1320 has multiple steps 1322 (as indicated by steps 0, 1, 2, and 3). Steps 1-3 may be provided by a digitized application that is executable on one or more pieces of inspection equipment. Step 0 of the inspection process may represent identifying the current inspection (e.g., the type of inspection, the object that is to be inspected, etc.). It may be beneficial to provide supplemental inspection data based upon a current step of an inspection process. To do this, the inspection equipment may discern a current inspection step that has been or is currently being implemented. The inspection instrument may provide an identifier for the discerned step to the data provider services, where supplemental data 1324 relevant to the identifier may be obtained and provided to the inspection equipment. The inspection equipment may then format and present at least a portion of the supplemental data on a presentation device (e.g., a display 1326) of the inspection equipment, thus providing the inspector or other operator with relevant information pertaining to a particular step of the inspection process.

For example, in the embodiment pictured in FIG. 13, “Inspection Equipment 1” 1302 may discern that an inspection is about to take place. Accordingly, the inspection information may be identified and an identifier for step 0 may be provided to the data provider services, here cloud-based services. While the current example uses step 0 to illustrate an introductory step where introductory information may be provided, other embodiments of providing introductory information may include providing such introductory information without specifying a particular introductory step, such as step 0. For example, in some embodiments, a piece of inspection equipment may provide the introductory information based upon the initialization of an inspection application or plan.

Because “Inspection Equipment 1” does not have direct communication coupling to the data provider services in the current example, “Inspection Equipment 1” may provide the identifier to “Inspection Equipment 2”, which does have a direct communication coupling to the data provider services. “Inspection Equipment 2” may relay the identifier to the data provider services, where the services may gather relevant supplemental data relevant to the current step identifier.

The relevant supplemental data may vary depending on a particular step of the process. For example, as mentioned above, step 0 may relate to the overall inspection. Accordingly, supplemental data relevant to the overall inspection and/or the overall object to be inspected may be provided. However, prior to, during, and/or post completing a particular step (e.g., step 1, 2, or 3) of the inspection process, different supplemental data may be useful. For example, the supplemental data for a particular step may provide audio, video, haptic feedback, and/or textual based instructions regarding proper technique useful for completing the particular step. Additionally, the supplemental data may include data relevant to the particular step and data obtained while implementing the particular step.

Once the supplemental data is gathered, the data provider services may provide the supplemental data to the inspection equipment requesting the supplemental data (e.g., “Inspection Equipment 1” via “Inspection Equipment 2” in the current example). Thus, the inspection equipment may present the supplemental data via a presentation device (e.g., display of “Inspection Equipment 1” in the current example).

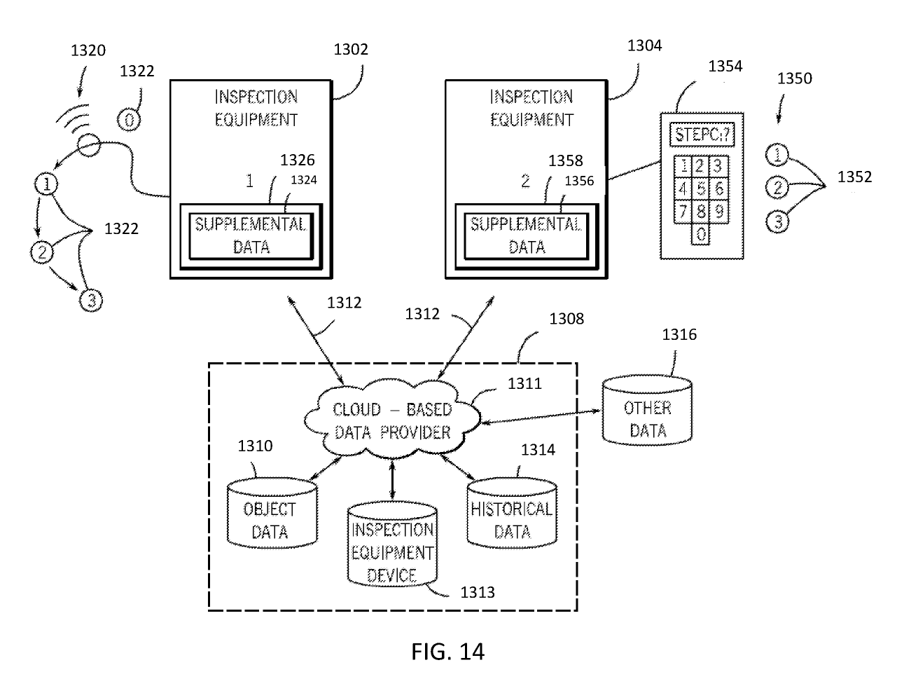

FIG. 14 is a schematic diagram of an alternate inspection system useful for providing step-specific supplemental data during an inspection, in accordance with an embodiment. With reference to both FIGS. 13 and 14, both “Inspection Equipment 1” and “Inspection Equipment 2” are directly communicatively coupled to the data provider service as illustrated by arrows 1312. Accordingly, “Inspection Equipment 1” does not submit supplemental data requests through “Inspection Equipment 2”, but instead submits the request directly to the data provider service. As previously discussed, the inspection process may include many steps and supplemental data relevant to the inspection steps may be presented via a presentation device (e.g., display). As discussed above, the supplemental data may include, for example: object data, relating to the object being inspected; inspection equipment data, relating to the inspection equipment; historical data, relating to previous inspections; or any other data.

In the current example “Inspection Equipment 2” is used to complete an inspection 1350 with inspection steps 1352. A user input device 1354 (e.g., a keypad, touchpad, microphone, etc.) may be used to enable an operator to specify a particular current step. An identifier of the current step may be provided to the data provider service (e.g., cloud-based data provider) where supplemental data 1356 is gathered. The supplemental data is provided to “Inspection Equipment 2” and may be presented on a display.

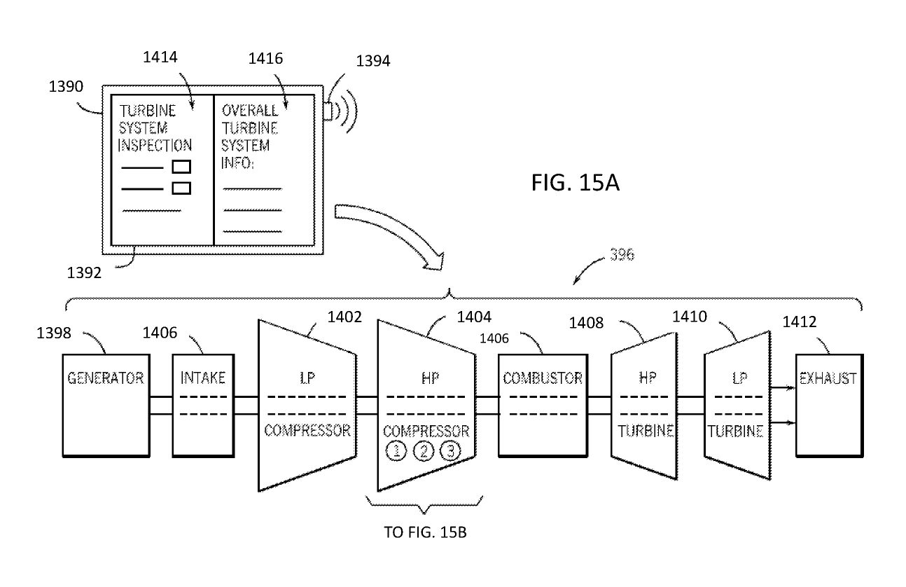

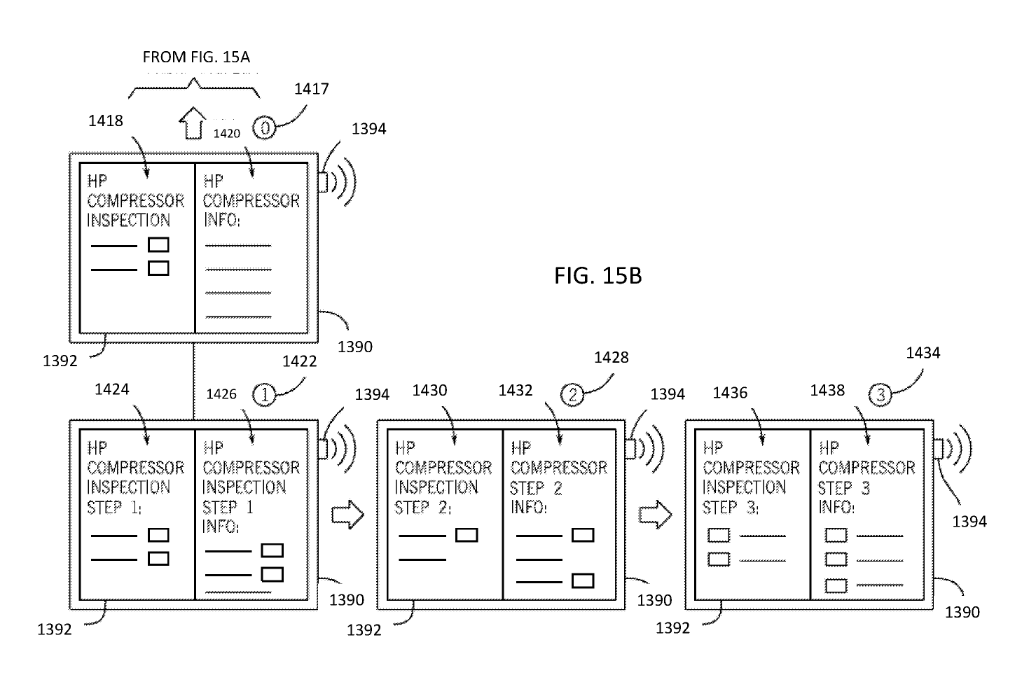

FIGS. 15A and 15B are a schematic view illustrating the presentation of step-specific supplemental data, in accordance with an embodiment. The inspection equipment 1390 is equipped with a display 1392 and/or one or more speakers 1394. The inspection equipment may be utilized to inspect an object with many components. For instance, in the current example, the inspection equipment is being used in the inspection of a turbine 1396 that includes a generator 1398, an intake 1400, a low-pressure compressor 1402, a high pressure compressor 1404, a combustor 1406, a high pressure turbine 1408, a low pressure turbine 1410, and an exhaust system 1412. The inspection equipment may determine that an inspection of the turbine system is planned and provide over view instructions 1414 for the overall turbine system inspection. Further, the inspection equipment may obtain supplemental data 1416 for the overall turbine system (e.g., according to process 290 of FIG. 12) based upon determining the object that is to be inspected (e.g., the turbine system). The supplemental data may be presented via the display and/or the speaker. For example, in the current embodiment, a split-screen provides the overview instructions and the supplemental data for the overall turbine system in the same view.

A particular component or feature of the object may be selected for inspection. For instance, in the current example, the inspection equipment is being used to inspect the compressor 1404. Upon detecting inspection of the high-pressure compressor (as indicated by the step 0 reference 1417), overview instructions 1418 and/or supplemental data 1420 relevant to the overview of the high-pressure compressor inspection may be provided (e.g., via the display and/or the speaker(s)). Upon detecting step 1 (as indicated by the step 1 reference 1422), Step 1 instructions 1424 and/or supplemental data 1426 relevant to Step of the high-pressure compressor inspection may be provided (e.g., via the display and/or the speaker(s)). Further, upon detecting step 2 (as indicated by the step 2 reference 1428), Step 2 instructions 1430 and/or supplemental data 1432 relevant to Step 2 of may be provided. Additionally, upon detecting step 3 (as indicated by the step 3 reference 1434), Step 3 instructions 1436 and/or supplemental data 1438 relevant to Step 3 may be provided, and so forth.

By utilizing step-based supplemental data, inspections may become more efficient and accurate. The step-based supplemental data may provide particular information of interest for an inspection step, may provide information relating to the object being inspected, historical inspection data, and/or information relating to the inspection equipment. Thus, an operator of the inspection equipment may be more informed and able to more accurately and cost-effectively complete an inspection.

In one embodiment, an inspection system is provided that includes a sensor package, a support platform, and a controller. The sensor package includes one or more sensors that are configured to obtain and to provide inspection data relating to at least one target object. The support platform may carry the sensor package to the at least one target object. The controller can cause actuators to align or index the one or more sensors of the sensor package with or on at least a portion of the target object at least during an inspection operation, and communicate with at least one operator that is remote from the target object. The communication can send inspection information from the one or more sensors to the at least one remote operator, and receive from the at least one remote operator one or more control instructions, programming instructions, and configuration instructions at the support platform. This can be to control the inspection operation of the sensor package. The controller can manipulate the one or more sensors at least in part in response to the received control instructions, programming instructions, and/or configuration instructions.

In one aspect, the system includes a display to present at least one graphical user interface to the remote operator, and the inspection management graphical user interface comprises a map and one or more icons. The icons can indicate the target object location on the map, and an inspection status of the target object. In one aspect, the characteristics of the icons vary to denote characteristics of the inspection data, the remote operator, the one or more sensors of the sensor package, one or more assets associated with target object, or a combination of two or more thereof. In one aspect, the sensor package is part of an inspection device and is at least a visual or optical system. In one aspect, the inspection device further includes a non-visual, non-destructive inspection and testing device.

In one aspect, the support platform includes a housing and the inspection device is at least partially disposed within the housing, and the housing is configured to be manipulated by the at least one remote operator via the receipt of the one or more control instructions, programming instructions, and configuration instructions. In one aspect, the controller can perform an inspection operation based at least in part on: obtaining inspection information, environmental information proximate to the support platform, or both the inspection information and the environmental information; and, then can automatically perform one or more actions or inspections in response to the obtained information. In one aspect, the one or more actions include indexing or aligning on a determined aspect of the target object and maintaining a stationary relationship of at least one of the inspection device, the housing, and the support platform relative to that determined aspect reactively to environmental effects that would urge the one or more sensors to otherwise move relative to that determined aspect. In one aspect, the one or more actions include indexing or aligning the inspection device on a determined aspect of the target object and executing one or move movements of at least one of the support platform, the housing, or the inspection device relative to that determined aspect so as to sequentially expose the sensor package to portions of the target object in a determined pattern over a period of time, and thereby to inspect of an area of the target object.

In one aspect, the inspection device is disposed in the housing, and the housing can respond to operator instructions by initiating movement of the visual inspection device, the non-visual inspection device or both the visual and non-visual inspection devices relative to the support platform, and thereby to manipulate the one or more sensors.

In one aspect, the operator is at least one person and the received control instructions, programming instructions, and/or configuration instructions are manually input by the operator into the controller and are based at least in part on a presentation of the visual inspection information, the non-visual inspection information or both the visual and non-visual inspection information generated by the corresponding visual inspection device, non-visual inspection device or both visual and non-visual inspection devices that are presented to the operator, and thereby to facilitate the operator manual input.

In one aspect, the controller can initiate a remote collaboration session between a first operator having access to the presentation, and a second operator generating and sending the one or more control instructions, programming instructions, and configuration instructions to the support platform, and the first and second operators are both located remotely from the support platform. In one aspect, the presentation includes a notes section that provides to the operator one or more of text, images, audio, video, or a combination of two or more thereof. In one aspect, a historical data archive is provided for inspection data relating to the target object, and the controller can to access at least the historical data archive.

In one aspect, the support platform is one of a plurality of support platforms that are configured to cooperatively inspect portions of the target object. The support platform has a plurality of sensor packages with each sensor package in a corresponding housing, and thereby a first sensor package of the plurality of sensor packages is configured to inspect one or more portions of the target object differently than a second sensor package of another housing. The controller can define a crash avoidance residence zone in order for the support platform to avoid contact with the target object, another support platform, or with another object other than the target object.

In one aspect, an inspection system includes a sensor package including one or more sensors that are configured to obtain and to provide inspection data relating to at least one target object, and the one or more sensors include at least a visual or optical system, and a non-visual, non-destructive inspection and testing device; a support platform configured to carry the sensor package to the at least one target object; a navigation device configured to provide at least location and direction information; a controller configured to receive the at least location and direction information, and to: align or index the one or more sensors of the sensor package to a determined aspect of the target object and execute one or move movements of the support platform relative to that determined aspect so as to sequentially expose the sensor package to portions of the target object in a determined pattern, and capture inspection information from the one or more sensors relating to the target object.

In one aspect, a method includes directing one or more sensors of a sensor package toward at least a portion of a target object at least during an inspection operation to generate inspection information; communicating with at least one operator that is remote from the target object the inspection information; receiving one or more of control instructions, programming instructions, and configuration instructions; and manipulating the one or more sensors at least in part in response to the received control instructions, programming instructions, and/or configuration instructions. In one aspect, the method includes defining a crash avoidance residence zone to avoid contact between a support platform for the sensor package and one or more of: the target object, another support platform, or with an object other than the target object or another support platform.

One or more specific embodiments are described herein. To provide a concise description of these embodiments, not all features of an actual implementation are described in the specification. In the development of any such actual implementation, as in any engineering or design project, numerous implementation-specific decisions must be made to achieve the developers' specific goals, such as compliance with system-related and business-related constraints, which may vary from one implementation to another. Moreover, such a development effort might be complex and time consuming, but would nevertheless be a routine undertaking of design, fabrication, and manufacture for those of ordinary skill having the benefit of this disclosure.

Embodiments of the present disclosure may apply to a variety of inspection and testing techniques, including non-destructive testing (NDT) or inspection systems. In the NDT system, certain techniques such as borescopic inspection, weld inspection, remote visual inspections, x-ray inspection, ultrasonic inspection, eddy current inspection, and the like, may be used to analyze and detect a variety of conditions, including but not limited to corrosion, equipment wear and tear, cracking, leaks, and so on. The techniques described herein provide for improved NDT systems suitable for borescopic inspection, remote visual inspections, x-ray inspection, ultrasonic inspection, and/or eddy current inspection, enabling enhanced data gathering, data analysis, inspection/testing processes, and NDT collaboration techniques.

The improved NDT systems described herein may include inspection equipment using wireless conduits suitable for communicatively coupling the inspection equipment to mobile devices, such as tablets, smart phones, and augmented reality eyeglasses; to computing devices, such as notebooks, laptops, workstations, personal computers; and to “cloud” computing systems, such as cloud-based NDT ecosystems, cloud analytics, cloud-based collaboration and workflow systems, distributed computing systems, expert systems and/or knowledge-based systems. Indeed, the techniques described herein may provide for enhanced NDT data gathering, analysis, and data distribution, thus improving the detection of undesired conditions, enhancing maintenance activities, and increasing returns on investment (ROI) of facilities and equipment.

Optionally, one or more of the processors described herein can detect and track objects from video signals and generate a video-loop of the video signals. The video-loop displays, for example, images of a trip of a person in a commercial site. The processors can combine recently acquired video signals with video signals in the historical data archive to create the video-loop. The processors receive a video and associated depth data from an image capture device (e.g., a camera). The processors can nominate foreground regions of interest in the video that may correspond to a designated object (e.g., a person or equipment) by performing, for example, non-parametric kernel density estimation on the received depth data. The processors can detect the object in the video by analyzing the nominated regions of interest using geometrical shapes (e.g., a three-dimensional ellipsoid, or the like) that resemble the size and shape of the designated object. The processors then extract a set of images (i.e., frames) from the video and/or from the historical data archive that include the detected object and generate the video-loop. Additionally, the processors can determine metadata associated with the object from the videos. The metadata in one example includes features such as location data (e.g., x-y coordinates) of the identified object and an appearance descriptor that represents the spatial distribution of color corresponding to the identified object.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

This written description uses examples to disclose the inventive subject matter, including the best mode, and also to enable a person of ordinary skill in the art to practice the invention, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An inspection system, comprising:
a sensor package comprising one or more sensors that are configured to obtain and to provide inspection data relating to at least one target object;
a support platform configured to carry the sensor package to the at least one target object; and
a controller configured to:
align or index the one or more sensors of the sensor package with or on at least a portion of the target object at least during an inspection operation,
communicate with at least one operator that is remote from the target object,
send inspection information from the one or more sensors to the at least one remote operator, and
receive, from the at least one remote operator, one or more control instructions, programming instructions, or configuration instructions at the support platform, and thereby to control the inspection operation of the sensor package, and
wherein the controller is further configured to manipulate the one or more sensors based at least in part in response to the one or more control instructions, programming instructions, or configuration instructions that are received.

2. The inspection system of claim 1, further comprising a display configured to present at least one inspection management graphical user interface to the at least one remote operator, and the inspection management graphical user interface comprises a map and one or more icons, the icons indicating:
the at least one target object location on the map, and
an inspection status of the at least one target object.

3. The inspection system of claim 2, wherein the display is configured to vary characteristics of the one or more icons to denote characteristics of the inspection data, the at least one remote operator, the one or more sensors of the sensor package, one or more assets associated with the at least one target object, or a combination of two or more thereof.

4. The inspection system of claim 1, wherein the sensor package is part of an inspection device and is at least a visual or optical system.

5. The inspection system of claim 4, wherein the inspection device further comprises a non-visual, non-destructive inspection and testing device.

6. The inspection system of claim 4, wherein the support platform further comprises a housing and the inspection device is at least partially disposed within the housing, and the housing is configured to be manipulated by the at least one remote operator via the receipt of the one or more control instructions, programming instructions, or configuration instructions.

7. The inspection system of claim 6, wherein the controller is further configured to perform an inspection operation based at least in part on:
obtaining inspection information, environmental information proximate to the support platform, or both the inspection information and the environmental information; and
performing automatically one or more actions or additional inspections in response to the obtained inspection information.

8. The inspection system of claim 7, wherein the one or more actions comprise indexing or aligning on a determined aspect of the target object and maintaining a stationary relationship of at least one of the inspection device, the housing, or the support platform relative to that determined aspect reactively to environmental effects that would urge the one or more sensors to otherwise move relative to that determined aspect.

9. The inspection system of claim 7, wherein the one or more actions comprise indexing or aligning the inspection device on a determined aspect of the target object and executing one or move movements of at least one of the support platform, the housing, or the inspection device relative to that determined aspect so as to sequentially expose the sensor package to portions of the target object in a determined pattern over a period of time, and thereby to inspect of an area of the target object.

10. The inspection system of claim 6, wherein the inspection device is disposed in the housing and includes a visual inspection device, and the housing is configured to respond to operator instructions by initiating movement of the visual inspection device, the non-visual, non-destructive inspection and testing device or both the visual inspection device and the non-visual, non-destructive inspection and testing devices relative to the support platform, and thereby to manipulate the one or more sensors.

11. The inspection system of claim 10, wherein the at least one operator is at least one person and the one or more control instructions, programming instructions, or configuration instructions that are received are manually input by the at least one operator into the controller and are based at least in part on a presentation of visual inspection information from the visual inspection device, non-visual inspection information from the non-visual, non-destructive inspection and testing device, or both the visual inspection information and the non-visual inspection information that are presented to the operator, and thereby to facilitate the input that is manually input by the operator.

12. The inspection system of claim 11, wherein the controller is further configured to initiate a remote collaboration session between a first operator having access to the presentation, and a second operator generating and sending the one or more control instructions, programming instructions, or configuration instructions to the support platform, and the first and second operators are both located remotely from the support platform.

13. The inspection system of claim 11, wherein the presentation includes a notes section configured to provide to the at least one operator one or more of text, images, audio, video, or a combination of two or more thereof.

14. The inspection system of claim 1, further comprising a historical data archive for inspection data relating to the at least one target object, and the controller is further configured to access at least the historical data archive.

15. The inspection system of claim 1, wherein the support platform is one of a plurality of support platforms that is configured to cooperatively inspect portions of the at least one target object.

16. The inspection system of claim 1, wherein the support platform has a plurality of sensor packages with each sensor package in a corresponding housing, and thereby a first sensor package of the plurality of sensor packages is configured to inspect one or more portions of the target object differently than a second sensor package of another housing.

17. The inspection system of claim 1, wherein the controller is configured to define a crash avoidance residence zone for the support platform to avoid contact with the at least one target object, another support platform, or with another object other than the target object.

18. The inspection system of claim 1, wherein the inspection data includes a video of a surveyed area, and wherein the controller is configured to add the video to previously archived video to create a video loop.

19. An inspection system, comprising:
a sensor package comprising one or more sensors that are configured to obtain and to provide inspection data relating to at least one target object, and the one or more sensors comprise at least (a) a visual or optical system and (b) a non-visual, non-destructive inspection and testing device;
a support platform configured to carry the sensor package to the at least one target object;
a navigation device configured to provide at least location and direction information;
a controller configured to receive the at least location and direction information, and to:
align or index the one or more sensors of the sensor package to a determined aspect of the target object and execute one or more movements of the support platform relative to that determined aspect so as to sequentially expose the sensor package to portions of the target object in a determined pattern and
capture inspection information from the one or more sensors relating to the target object.

20. A method, comprising:
directing one or more sensors of a sensor package toward at least a portion of a target object at least during an inspection operation to generate inspection information;
communicating the inspection information with at least one operator that is remote from the target object;
receiving one or more of control instructions, programming instructions, or configuration instructions; and
manipulating the one or more sensors at least in part in response to the one or more control instructions, programming instructions, or configuration instructions that are received.

21. The method of claim 20, further comprising defining a crash avoidance residence zone to avoid contact between a support platform for the sensor package and one or more of: the target object, another support platform, or with an object other than the target object or another support platform.
